(19) United States
(12) Patent Application Publication
(10) Pub. No.: US 2009/0138466 A1
(43) Pub. Date: May 28, 2009

(54) System and Method for Search

(75) Inventors: Daniel J. Henry, Troy, MI (US); Michael R. Bascobert, Clarkston, MI (US)

Correspondence Address: Daniel J. Henry, 2980 Townhill, Troy, MI, 48084, US

(73) Assignee: AccuPatent, Inc., Troy, MI (US)

(21) Appl. No.: 12/193,039

(22) Filed: Aug. 17, 2008

Related U.S. Application Data
(60) Provisional application No. 60/956,407, filed on Aug. 17, 2007.
(60) Provisional application No. 61/049,813, filed on May 2, 2008.

(51) Int. Cl. G06F 7/06; G06F 17/30

(52) U.S. Cl. 707/5; 707/3; 707/E17.014; 707/E17.019

(57) ABSTRACT

A method for associating graphical information and text information includes providing the graphical information, the graphical information comprising at least one identifier in the graphical information for identifying at least one portion of the graphical information. The method further includes providing the text information and associating the portion with the text information through a commonality between the identifier and the text information.

### RELATED APPLICATIONS

The present application claims priority to U.S. Provisional Application Ser. No. 60/956,407, titled “System and Method for Analyzing a Document,” filed on Aug. 17, 2007, and also claims priority to U.S. Provisional Application Ser. No. 61/049,813, titled “System and Method for Analyzing Documents,” filed on May 2, 2008, wherein the contents of the above mentioned applications are hereby incorporated by reference in their entirety.

### TECHNICAL FIELD

The embodiments described herein are generally directed to document analysis and search technology.

### BACKGROUND

Conventional word processing, typing or creation of complex legal documents, such as patents, commonly utilizes a detailed review to ensure accuracy. Litigators and other analysts that review issued patents many times look for critical information related to those documents for a multitude of purposes.

As discussed herein, the systems and methods provide for document analysis. Systems such as spell checkers and grammar checkers only look to a particular word (in the case of a spell checker) and a sentence (in the case of a grammar checker) and only attempt to identify basic spelling and grammar errors. However, these systems do not provide for checking or verification within the context of an entire document that may also include graphical elements and do not look for more complex errors or to extract particular information.

Conventional document display devices provide text or graphical information related to a document, such as a patent download service. However, such conventional document display devices do not interrelate critical information in such documents to allow correlation of important information across multiple information sources. Moreover, such devices do not interrelate graphical and textual elements.

With respect to programming languages, certain tools are used by compilers and/or interpreters to verify the accuracy of structured-software language code. However, software-language lexers (e.g., a lexical analysis tool) differ from natural language documents (e.g., a document produced for humans) in that lexers use rigid rules for interpreting keywords and structure. Natural language documents such as patent application or legal briefs are loosely structured when compared to rigid programming language requirements. Thus, strict rule-based application of lexical analysis is not possible. Moreover, current natural language processing (NLP) systems are not capable of document-based analysis.

Moreover, conventional search methods may not provide relevant information. In an example, documents are produced from a search that may include search keywords, but are cluttered through the document, or non-existent. Thus, an improved search method is desired.

### BRIEF DESCRIPTION OF THE DRAWINGS

The present invention will now be described, by way of example, with reference to the accompanying drawings, in which:

FIG. 1 shows an example of a high-level processing apparatus for use with the examples described herein.

FIG. 1A is an alternative system that may further include sources of information external to the information provided by the user.

FIG. 2 shows an example of a system for information analysis that includes a server/processor, a user, and multiple information repositories.

FIG. 3 shows a flow diagram of the overview for information analysis, shown as an example of a patent application document analysis.

FIG. 4 shows another analysis example.

FIG. 5 shows an example of a process for extracting information or identifying errors related to the specification and claim sections in a patent or patent application;

FIG. 6 shows an example of a process for identifying errors in the specification and claims of a patent document;

FIG. 7 shows an example for processing drawing information is shown and described;

FIG. 8 shows another example for a process flow 700 is shown for identifying specification and drawing errors is described;

FIG. 9 shows association of specification terms, claim terms and drawing element numbers;

FIG. 10 shows an output to a user;

FIG. 11 shows prosecution history analysis of a patent application or patent;

FIG. 12 shows a search in an attempt to identify web pages that employ or use certain claim or specification terms;

FIG. 13 shows another example relating to classification and sub-classification;

FIG. 14 shows an alternative output for a user;

FIG. 15 shows an alternative example that employs a translation program to allow for searching of foreign patent databases;

FIG. 16 shows an alternative example employing heuristics to generate claims that include specification element numbers;

FIG. 17 shows an alternative example that generates a summary and an abstract from the claims of a patent document;

FIG. 18 shows an alternative example to output drawings for the user that include the element number and specification element name;

FIG. 19 shows an OCR process adapted to reading patent drawings and figures;

FIG. 20 includes an exemplary patent drawing page that includes multiple non-contacting regions;

FIG. 21 is a functional flow diagram of a document analysis system for use with the methods and systems described herein; and

FIG. 22 shows a word distribution map for use with the methods and systems described herein.

FIG. 23 shows an example of a processing apparatus according to examples described herein.

FIG. 24 shows an example of a processing apparatus according to examples described herein.

FIG. 25 shows an example of a processing apparatus according to examples described herein.

FIG. 26 shows a diagrammatical view according to an example of an example described herein.

FIG. 27 shows a diagrammatical view according to an example described herein.

FIG. 28 shows a diagrammatical view according to an example described herein.

FIG. 29 shows a diagrammatical view according to an example described herein.

FIG. 30 shows a diagrammatical view according to an example described herein.

FIG. 31 shows a diagrammatical view according to an example described herein.

FIG. 32 shows a diagrammatical view according to an example described herein.

FIG. 33 is an example of a document type classification tree.

FIG. 34 is an example of a document having sections.

FIG. 35 is an example of document analysis for improved indexing, searching, and display.

FIG. 36 shows an analysis of a document to determine the highly relevant text that may be used in indexing and searching.

FIG. 37 is an example of a general web page that may be sectionalized and analyzed by a general web page rule.

FIG. 38 is an example of a document analysis method.

FIG. 39 is an example of a document indexing method.

FIG. 40 is an example of a document search method.

FIG. 41 is a method for indexing, searching, presenting results, and post processing documents in a search and review system.

FIG. 42 is a method of searching a document based on document type.

FIG. 43 shows the fields used for search, where each field may be searched and weighted individually to determine relevancy.

FIG. 44 is a relevancy ranking method where each field may have boosting applied to make the field more relevant than others.

FIG. 45 is a relevancy ranking method for a patent “infringement” search.

FIG. 46 is a general relevancy ranking method for patent documents.

FIG. 47 is a method of performing a search based on a document identifier.

FIG. 48 is a method of creating combinations of search results related to search terms.

FIG. 49 is a method of identifying the most relevant image related to search terms.

FIG. 50 is a method of relating images to certain portions of a text document.

FIG. 51 is a method of determining relevancy of documents (or sections of documents) based on the location of search terms within the text.

FIG. 52 is a method of determining relevancy of images based on the location of search terms within the image and/or the document.

FIG. 53 is a search term broadening method.

FIG. 54 is an example of a method of determining relevancy after search results are retrieved.

FIG. 55 is an example of a method for generally indexing and searching documents.

FIG. 56 is an example, where indexing may be performed on the document text and document analysis and relevancy determination is performed after indexing.

FIG. 57 is a method for identifying text elements in graphical objects, which may include patent documents.

FIG. 58 is an example of a method for extracting relevant elements and/or terms from a document.

FIG. 59 is a method for relating text and/or terms within a document.

FIG. 60 is a method of listing element names and numbers on a drawing page of a patent.

FIG. 61 is an example of a drawing page before markup.

FIG. 62 is an example of a drawing page after markup.

FIG. 63 is an example of a search results screen for review by a user.

### DETAILED DESCRIPTION

The present application incorporates by reference U.S. provisional patent application Nos. 60/956,407 and 61/049,813 in their entirety into the specification. Referring now to the drawings, illustrative embodiments are shown in detail. Although the drawings represent the embodiments, the drawings are not necessarily to scale and certain features may be exaggerated to better illustrate and explain an embodiment. Further, the embodiments described herein are not intended to be exhaustive or otherwise limit or restrict the invention to the precise form and configuration shown in the drawings and disclosed in the following detailed description. Discussed herein are examples of document analysis and searching. The methods disclosed herein may be applied to a variety of document types, including text-based documents, mixed-text and graphics, video, audio, and combinations thereof. Information for analyzing the document may come from the document itself, as contained in metadata, for example, or it may be generated from the document using rules. The rules may be determined by classifying the document type, or manually. Using the rules, the document may be processed to determine which words or images are more relevant than others. Additionally, the document may be processed to allow for tuned relevancy depending upon the type of search applied, and how to present the results with improved or enhanced relevancy. In addition, the presentation of each search result may be improved by providing the most relevant portion of the document for initial review by the user, including the most relevant image. The documents discussed herein may apply to patent documents, books, web pages, medical records, SEC documents, legal documents, etc. Examples of document types are provided herein and are not intended to be exhaustive. The examples show that different rules may apply depending upon the document type, and where documents are encountered that are not discussed herein, rules may be developed for those documents in the spirit of rule building shown in the examples below.

[[FIRST PROVISIONAL INSERTED]] One example described herein is a system and method for verifying a patent document or patent application. However, other applications may include analyzing a patent document itself, as well as placing the elements of the patent document in context of other documents, including the patent file wrapper. Yet another application may include verifying the contents of legal briefs. Although a patent or patent application is used in the following examples, it will be understood that the processes described herein apply to and may be used with any document.

In one example, a document is either uploaded to a computer system by a user or extracted from a storage device. The document may be any form of a written or graphical instrument, such as a 10-K, 10-Q, FDA phase trial documents, patent, publication, patent application, trial or appellate brief, legal opinion, doctoral thesis, or any other document having text, graphical components or both.

The document is processed by the computer system for errors, to extract specific pieces of information, or to mark-up the document. For example, the text portion of the document may be analyzed to identify errors therein. The errors may be determined based on the type of document. For example, where a patent application is processed the claim terms may be checked against the detailed description. Graphical components may be referenced by or associated with text portions referencing such graphical portions of a figure (e.g., a figure of a patent drawing). Relevant portions of either the text or graphics may be extracted from the document and output in a form, report format, or placed back into the document as comments. The graphical components or text may be marked with relevant information such as element names or colorized to distinguish each graphical element from each other.

Upon identifying such relevant information, further analysis can be conducted relevant to the document or information contained therein. For example, based on information extracted from the document, analysis of other sources of information or other documents may be conducted to obtain additional information relating to the document.

An output is then provided to the user. For example, a report may be generated made available to the user as a file (e.g., a Word® document, a PDF document, a spreadsheet, a text file, etc.) or a hard copy. Alternatively, a marked up version of the original document may be presented to the user in a digital or hardcopy format. In another example, an output comprising a hybrid of any of these output formats may be provided to the user as well.

Other types of documents that may use verification or checking include a response to an office action or an appeal brief (both relating to the USPTO). Here, any quotations or block text may be checked for accuracy against a reference. In an example, the text of a block quote or quotation is checked against the patent document for accuracy as well as the column & line number citation. In another example, a quote from an Examiner may be checked for accuracy against an office action that is in PDF form and loaded into the system. In another example, claim quotes from the argument section of a response may be checked against the as-amended claims for final accuracy.

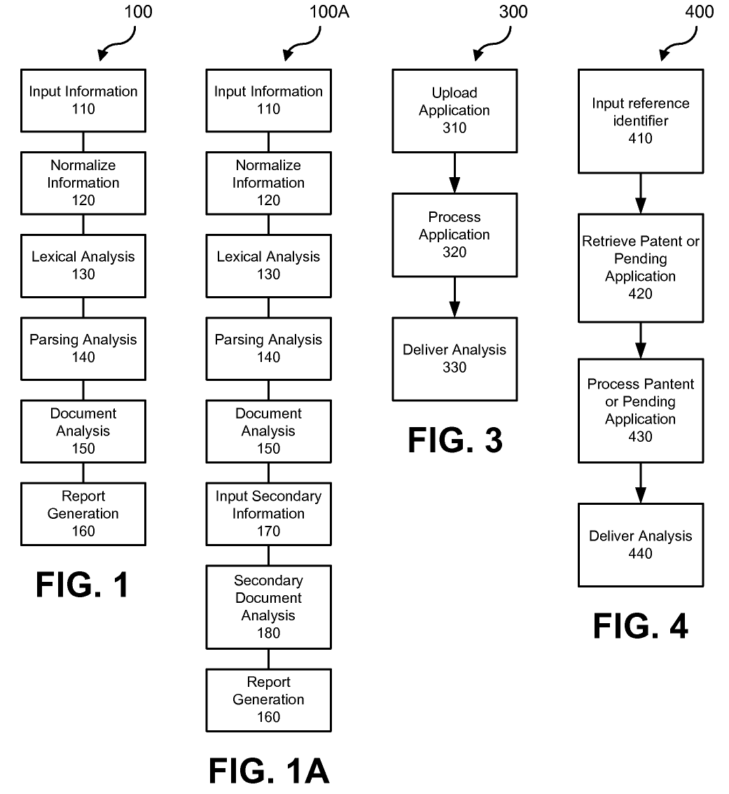

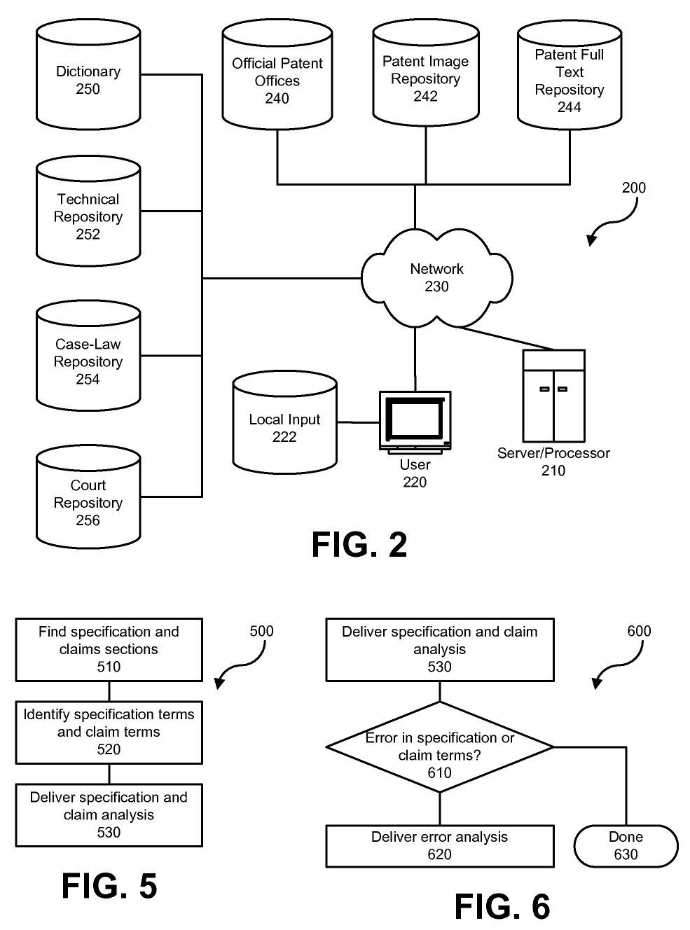

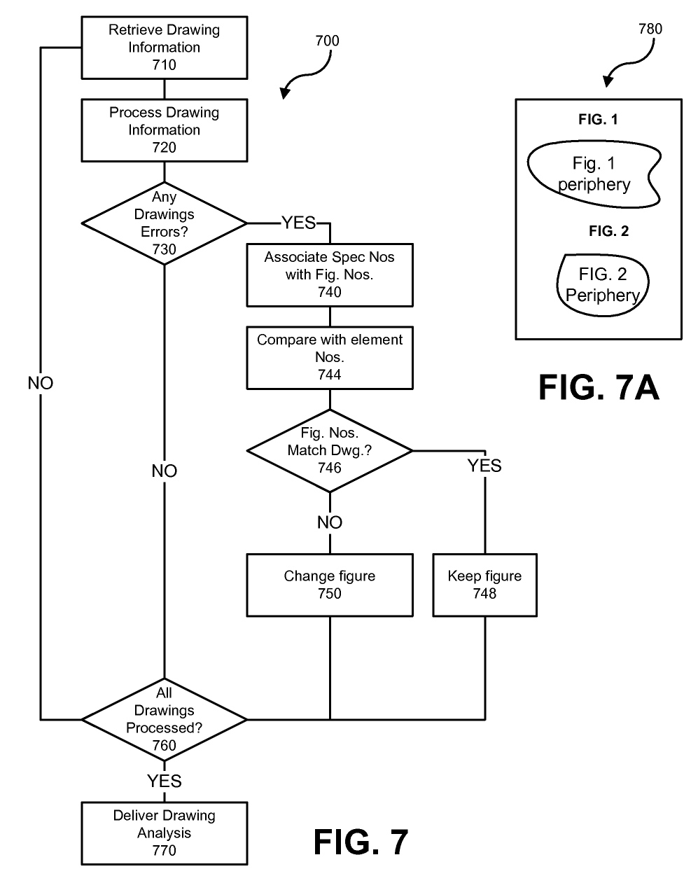

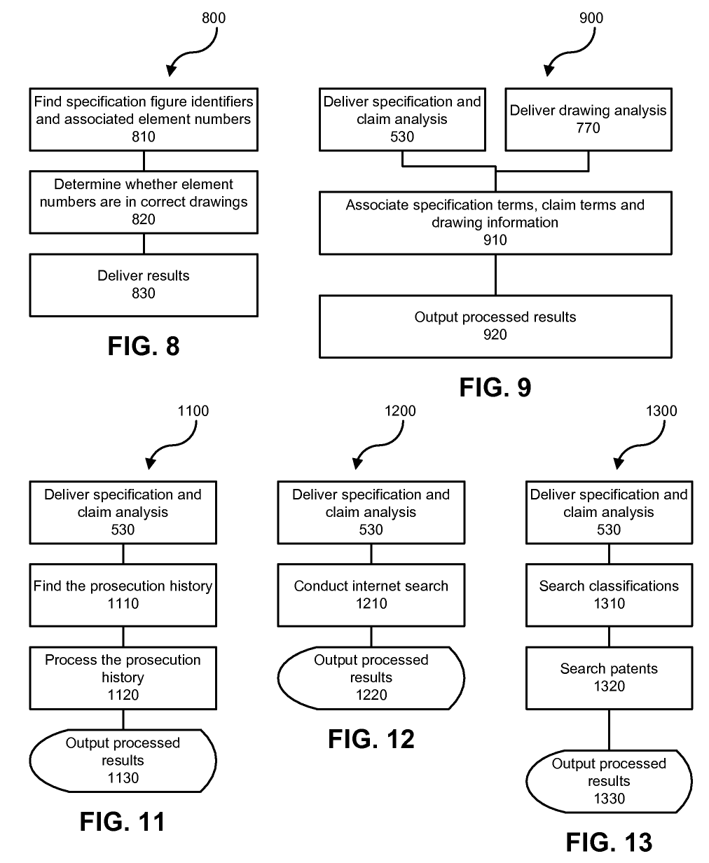

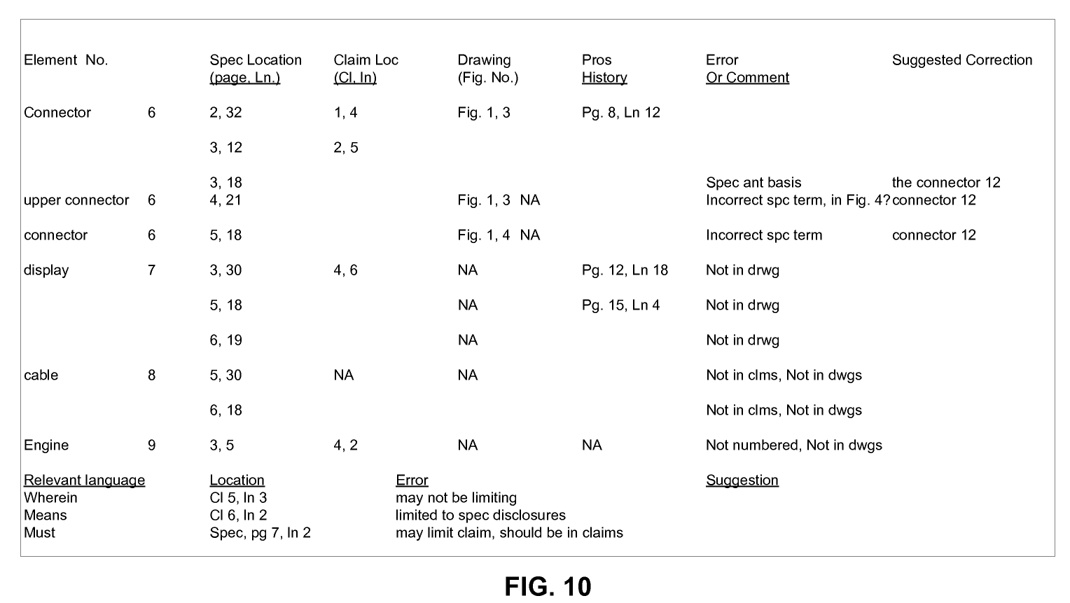

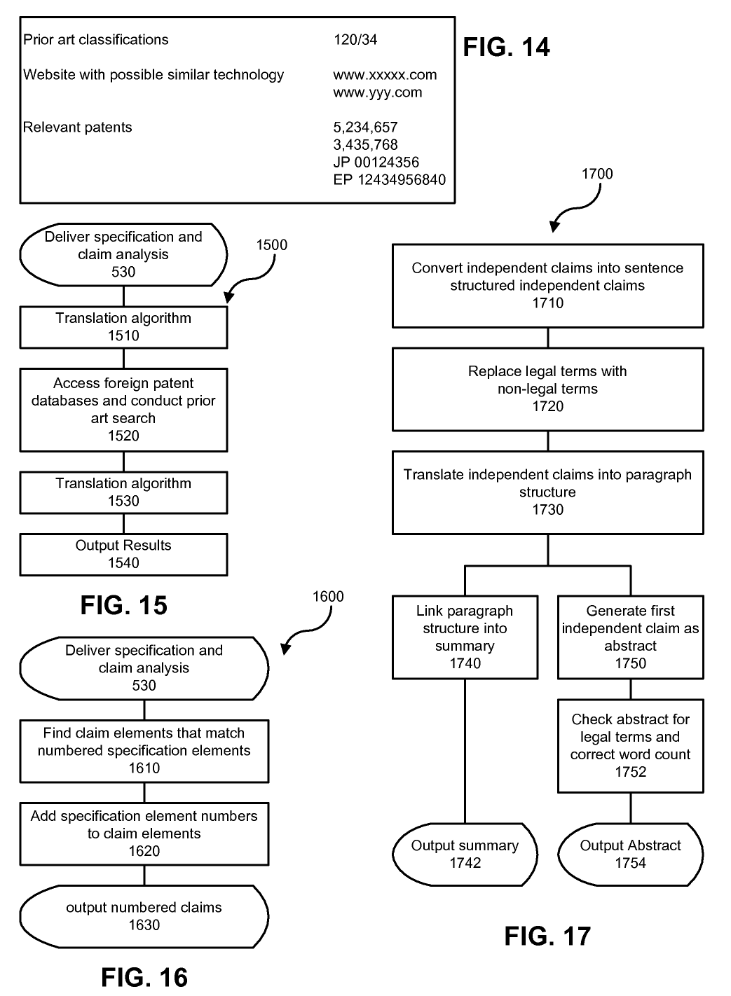

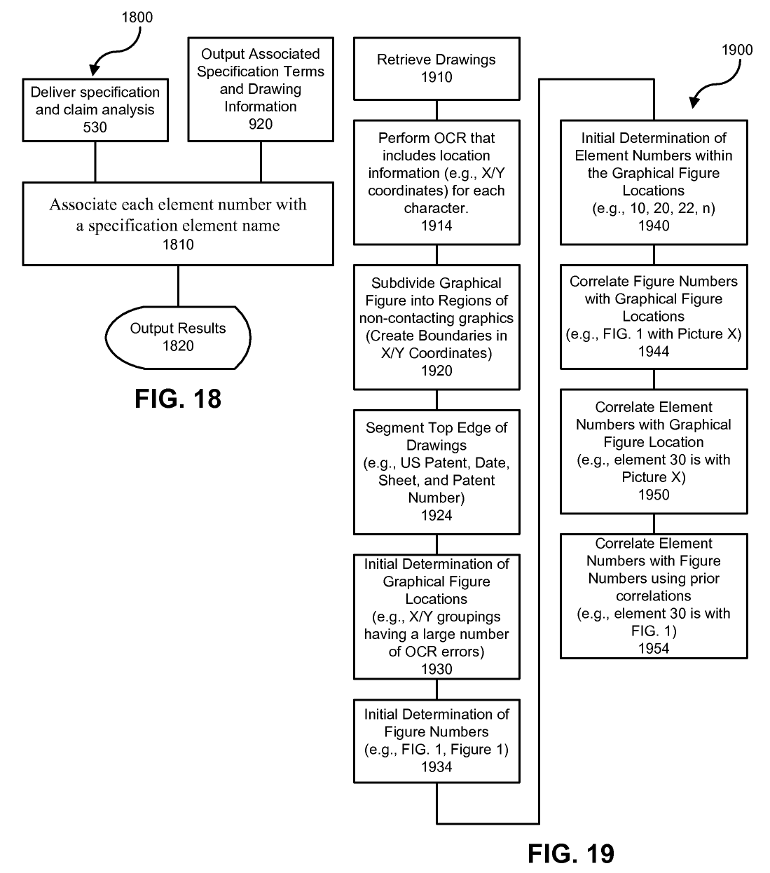

FIG. 1 is an example of a high-level processing apparatus 100 which is used to input files or information, process the information, and report findings to a user. At input information block 110, a user may select the starting documents to be analyzed. In an example, the user may input a patent application and drawings. The inputs may be in the form of Microsoft Word® documents, PDF documents, TIFF files, images (e.g., TIFF, JPEG, etc.) HTML/XML format, flat text, and/or other formats storing information.

Normalize information block 120 is used to convert the information into a standard format and store metadata about the information, files, and their contents. For example, a portion of a patent application may include “DETAILED DESCRIPTION” which may be in upper case, bold, and/or underlined. Thus, the normalized data will include the upper case, bold, and underlined information as well as that data's position in the input. For inputs that are in graphical format, such as a TIFF file or PDF file that does not contain metadata, the text and symbol information are converted first using optical character recognition (OCR) and then metadata is captured. In another example, where a PDF file (or other format) includes graphical information and metadata, e.g. a tagged PDF, the files may contain structure information. Such information may include embedded text information (e.g., the graphical representation and the text), figure information, and location for graphical elements, lists, tables etc. In an example of graphical information in a patent drawing, the element numbers, and/or figure numbers may be determined using OCR methods and metadata including position information in the graphical context of the drawing sheet and/or figure may be recorded.

Lexical analysis block 130 then takes the normalized information (e.g., characters) and converts them into a sequence of tokens. The tokens are typically words, for example, the characters “a”, “n”, “d” in sequence and adjacent to one another are tokenized into “and” and the metadata is then normalized between each of the characters into a normalized metadata for the token. In the example, character “a” comes before character “n” and “d” at which time lexical analysis block 130 normalizes the position information for the token to the position of “a” as the start location of the token and the position of “d” as the end location. Location of the “n” may be less relevant and discarded if desired. In an example of a graphical patent drawing, the normalized metadata may include the position information in two dimensions and may include the boundaries of an element number found in the OCR process. For example, the found element number “100” may include metadata that includes normalized rectangular pixel information, e.g. what are the location of the pixels occupied by element number “100” (explained below in detail).

Parsing analysis block 140 then takes the tokens provided by lexical analysis block 130 and provides meaning to tokens and/or groups of tokens. To an extent, parsing analysis block 140 may further group the tokens provided by lexical analysis block 130 and create larger tokens (e.g., chunks) that have meaning. In a preliminary search, chunks may be found using the Backus-Naur algorithm (e.g. using a system such as Yacc). A Yacc-based search may find simple structures such as dates (e.g., “January 1, 2007” or “1/1/07”), patent numbers (e.g., U.S. Pat. No. 9,999,999), patent application numbers (e.g., Ser. No. 99/999,999), or other chunks that have deterministic definitions as to structure. Parsing analysis block 140 then defines metadata for the particular chunk (e.g., “January 1, 2007” includes metadata identifying the chunk as a “date”).

Further analysis includes parsing through element numbers of a specification. For example, an element may be located by identifying a series of tokens such as “an”, “engine”, “20”. Here, parsing analysis block 140 identifies an element in the specification by pattern matching the token “an” followed by a noun token “engine” followed by a number token “20”. Thus, the element is identified as “engine” which includes metadata defining the use of “a” or “an” as the first introduction as well as the element number “20”. The first introduction metadata is useful, for example, when later identifying in the information whether the element is improperly re-introduced with “a” or “an” rather than used with “the”. Such analysis is explained in detail below.

Other chunks may be determined from the information structure, such as the title, cross-reference to related applications, statements regarding federally sponsored research or development, background of the invention, summary, brief description of the drawings, detailed description, claims, abstract, a reference to a sequence listing, a table, a computer program listing, a compact disc appendix, etc. In this sense, parsing analysis block 140 generates a hierarchical view of the information that may include smaller chunks as contained within larger chunks. For example, the element chunks may be included in the detailed description chunk. In this way, the context or location and/or use for the chunks is resolved for further analysis of the entire document (e.g., a cumulative document analysis).

Document analysis 150 then reviews the entirety of the information in the context of a particular document. For example, the specification elements may be checked for consistency against the claims. In another example, the specification element numbers may be checked for consistency against the figures. Moreover, the specification element numbers may be checked against the claims. In another example, the claim terms may be checked against the specification for usage (e.g., claim terms should generally be used in the specification). In another example, the claim terms also used in the specification are checked for usage in the figures.

An example of document analysis tasks may include, for example, those included in consistent element naming, consistent element numbering, specification elements are used in the figures, claim elements cross reference to figures, identify keywords (e.g., must, necessary, etc.) in information (e.g., spec., claims), appropriate antecedent basis for claim elements, does each claim start with a capital letter and end in a period, proper claim dependency, does the abstract contain the appropriate word count, etc. Document analysis 150 is further explained in detail below.

Report generation block 160 takes the chunks, tokens, and analysis performed and constructs an organized report for the user that indicates errors, warnings, and other useful information (e.g., a parts list of element names and element numbers, an accounting of claims and claim types such as 3 independent claims and 20 total claims). The errors, warnings, and other information may be placed in a separate document or they may be added to the original document.

FIG. 1A is an alternative system 100A that may further include sources of information external to the information provided in input information block 110. Input secondary information block 170 provides external information from other sources, e.g. documents, databases, etc. that facilitates further analysis of the document, chunks, and/or tokens. The secondary information may use identified tokens or chunks and further input external information. For example, a standard dictionary may be used to check whether or not the claim words are present and defined in the dictionary. If so, the dictionary definition may be reported to the user in a separate report of claim terms. In another example, where a token or chunk is identified as a patent that may be included by reference, a patent repository may be queried for particular information used to check the inventor name (if used), the filing date, etc.

Secondary document analysis block 180 takes tokens/chunks from the information and processes it in light of the secondary information obtained in input secondary information block 170. For example, where a claim term is not included in a dictionary, a warning may be generated that indicates that the claim term is not a “common” word. Moreover, if the claim term is not used in the specification, a warning may be generated that indicates that the word may require further use or definition. An example may be a claim that includes “a hose sealingly connected to a fitting”. The claim term “sealingly” may not be present in either the specification or the dictionary. In this case, although the word “seal” is maintained in the dictionary and may be used in the specification, the warning may allow the user to add a sentence or paragraph explaining the broad meaning of “sealingly” if so desired rather than relying on an unknown person's interpretation of “sealingly” in light of “to seal”.

In another example, a patent included by reference is checked against the secondary information for consistency. For example, the information may include an incorrect filing date or inventor which is found by comparing the chunk with the secondary information from the patent repository (e.g., inventor name, filing date, assignee, etc.). Other examples may include verifying information such as chemical formulas and/or sequences (e.g., whether they are reference properly and used consistently).

Examples of secondary information used for litigation analysis may include court records (e.g., PACER records), file histories (obtained, e.g., from the USPTO database), or case law (e.g., obtained from LEXIS®, WESTLAW®, BNA®, etc.). Using case law, for example, claim terms may be identified as litigated by a particular judge or court, such as the Federal Circuit. These cases may then be reviewed by the user for possible adverse meanings as interpreted by the courts.

Report generation block 160 then includes further errors, warnings, or other useful information including warnings or errors utilizing the secondary information.

Referring now to FIG. 2, an example of a system for information analysis 200 includes a server/processor 210 and a user 220. A network 230 generally provides a medium for information interchange between any number of components, including server/processor 210 and user 220. As discussed herein, network 230 may include a single network or any number of networks providing connectivity to certain components (e.g. a wired, wireless, optical network that may include in part the Internet). Alternatively, network 230 is not a necessary component and may be omitted where more than one component is part of a single computing unit. In an example, network 230 may not be required where the system and methods described herein are part of a stand-alone system.

Local inputs 222 may be used by user 220 to provide inputs, e.g. files such as Microsoft Word® documents, PDF documents, TIFF files etc. to the system. Processor 210 then takes the files input by user 220, analyzes/processes them, and sends a report back to user 220. The user may use a secure communication path to server/processor 210 such as “HTTPS” (a common network encryption/authentication system) or other encrypted communication protocols to avoid the possibility of privileged documents being intercepted. In general, upload to processor 210 may include a web-based interface that allows the user to select local files, input patent numbers or published application numbers, a docket number (e.g., for bill tracking), and other information. Delivery of analyzed files may be performed by processor 210 by sending the user an e-mail or the user may log-in using a web interface that allows the user to download the files.

In the example of a patent document, each document sent by user 220 is kept in secrecy and is not viewed, or viewable, by a human. All files are analyzed by machine and files sent from user 220 and any temporary files are on-the-fly encrypted when received and stored only temporarily during the analyzing process. Then analysis is complete and reports are sent to user 220 and any temporary files are permanently erased. Such encryption algorithms are readily available. An example of encryption systems is TrueCrypt available at “http://www.truecrypt.org/”. Any intermediate results or temporary files are also encrypted on-the-fly so that there is no possibility of human readable materials being readable, even temporarily. Such safeguards are used, for example, to avoid the possibility of disclosure. In an example of preserving foreign patent rights, a patent application should be kept confidential or under the provisions of a confidentiality agreement to prevent disclosure before filing.

Other information repositories may also be used by processor 210 such as when the user requests analysis of a published application or patent. In such cases, server processor 210 may receive an identifier, such as a patent number or published application number, and queries other information repositories to get the information. For example, an official patent source 240 (e.g., the United States Patent and Trademark Office, foreign patent offices such as the European Patent Office or Japanese Patent Office, WIPO, Esp@cenet, or other public or private patent offices or repositories) may be queried for relevant information. Other private sources may also be used that may include a patent image repository 242 and/or a patent full-text repository 244. In general, patent repositories 240, 242, 244 may be any storage facility or device for storing or maintaining text, drawing, patent family information (e.g. continuity data), or other information.

If the user requests secondary information being brought to bear on the analysis, other repositories may also be queried to provide data. Examples of secondary repositories may include a dictionary 250, a technical repository 252, a case-law repository 254, and a court repository 256. Other information repositories may be simply added and queried depending upon the type of information analyzed or if other sources of information become available. In the example where dictionary 250 is utilized, claim language may be compared against words contained in dictionary 250 to determine whether the words exist and/or whether they are common words. Technical repository 252 may be used to determine if certain words are terms of art, if for example the words are not found in a dictionary. To determine if claim terms have been litigated, construed by a District Court (or a particular District Court Judge), and whether the Federal Circuit or other appellate court has weighed in on claim construction, case-law repository 254 may be queried. In other cases, for example when the user requests a litigation report, court repository 256 may be queried to determine if the patent identified by the user is currently in litigation.

Referring now to FIGS. 2 and 3, a flow diagram 300 is shown of the overview for information analysis, shown here as an example of a patent application document.

The process begins at step 310 where a patent or patent application is retrieved from a source location and loaded onto server/processor 310. The patent or patent application may be retrieved from official patent offices 240, patent image repository 242, patent full text repository 244, and/or uploaded by user 220. Regarding any document other than a patent or patent application, any known source or device may be employed for storage and retrieval of such document. It will be understood by those skilled in the art that the patent or patent application may be obtained from any storage area whether stored locally or external to server/processor 210.

In step 320, the patent or patent application is processed by a server/processor 210 to extract information or identify errors. In one example, the drawings are reviewed for errors or associated with specification and claim information (described in detail below). In another example, the specification is reviewed for consistency of terms, proper language usage or other features as may be required by appropriate patent laws. In yet a further example, the claims are reviewed for antecedent basis or other errors. It will be readily understood by one skilled in the art that the patent or patent application may be reviewed for any known or foreseeable errors or any information may be extracted therefrom.

In step 330, an analysis of the processed application is output or delivered by server/processor 210 to user 220. The output may take any known form, including a report printed by or displayed on the terminal of user 220 or may be locally stored or otherwise employed by server/processor 210. In one example, user 220 includes a terminal that provides an interactive display showing the marked-up patent or patent application that allows the user to interactively review extracted information in an easily readable format, correct errors, or request additional information. In another example, the interactive display provides drop-down boxes with suggested corrections to the identified errors. In yet a further example, server/processor 210 prints a hard copy of the results of the analysis. It will be readily understood that any other known means of displaying or providing an output of the processed patents or patent application may be employed.

Other marked-up forms of documents may also be created by processor 210 and sent to user 220 as an output. For example, a Microsoft Word® document may use a red-line or comment feature to provide warnings and errors within the source document provided by user 220. In this way, modification and tracking of each warning or error is shown for simple modifications or when appropriate user 220 may ignore the warnings. User 220 may then “delete” a comment after, for example, an element name or number is modified. Additionally, marked-up PDF documents may be sent to user 220 that display in the text or in the drawings where error and/or warnings are present. An example may be where element numbers are used in a figure but not referenced in the specification of a patent application, the number in the drawing may have a red circle superimposed or highlighted over the drawing that identifies it to the user. In another example, where a PDF text file was provided by the user, errors and warnings may be provided as highlighted regions of the document.

Referring to FIG. 4, another example of a process 400 according to an example is shown and described. A patent or patent application reference identifier, such as an application number, docket number, publication number or patent number, is input by user 220 in step 410. The reference identifier may also be a computer indicator or other non-human entered identifier such as a cookie stored on the user's computer. In step 420, server/processor 210 retrieves the patent or patent application from patent repositories 240, 242, 244 or another repository through referencing the appropriate document in the repository with the reference identifier. The repository responds by retrieving and dispatching the appropriate patent or patent application information to server/processor 210 which may include full-text information, front-page information, and/or graphical information (e.g., figures and drawings). Server/processor 210 then processes the patent or patent application in step 430 for errors or to extract information. In step 440, results of the processed patent or patent application are output to user 220.

It will be understood that the above referenced processes may take place through a network, such as network 230, the Internet or other medium, or may be performed entirely locally by the user's local computer.

Referring now to FIG. 5, an example of a process 500 for extracting information or identifying errors related to the specification and claim sections in a patent or patent application is shown and described. In FIG. 5, the specification and claim sections in a patent or patent application are identified in step 510. In one example, server/processor 210 identifies the top portion of the specification by conducting a search for the word “specification” in a specific text, font or format that is commonly used or required as the title of the specification section in the patent or patent application. For example, a search may be conducted for the word “specification” in all caps, bold text, underlined text, centered or other font or text specific format. In another example, the word “specification” is identified by looking for the word “specification” in a single paragraph having no more than three words, one of which is the word “specification” having a first capital letter or being in all caps. As will be understood by one skilled in the art, such formats are commonly associated with traditional patent drafting methods or storage formats of patents. However, the present examples are not intended to be limited by the specific examples herein and any format commonly associated with such terms may be searched.

When multiple methods are used to determine a section in the document, a confidence of the correctness of assigning the section may also be employed. For example, where “specification” is in all caps and centered, there is a higher confidence than when “specification” is found within in a paragraph or at the end of the document vs. a general location more towards the beginning of the document. In this way, multiple possible beginnings of a section may be found, but the one with the highest confidence will be used to determine the section start. Such a confidence test may be used for all sections within the document, given their own unique wording, structure, and location within the document. Of course, for a patent application as filed, the specification and claims section are different than the full-text information taken from the United States Patent Office, as an example. Thus, for each section there may be different locations and structures depending upon the source of the document, each of which is detectable and easily added to the applicable heuristic.

In the claim section, server/processor 210 may, for example, identify the beginning of the claims section of the patent or patent application in a similar fashion as for the specification by searching for the word “claims” with text or format specific identifiers. The end of the “claims” section thereafter may be identified by similar means as described above, such as by looking for the term “abstract” at the end of the claims or the term “abstract” that follows the last claim number.

In an example, the area between the start of the specification and the start of the claims is deemed as the specification for example in a patent application or a published patent, while the area from the start of the claims to the end of the claims is deemed as the claims section. When the document is a full-text published patent (e.g., from the USPTO), then the claims may be immediately following the front-page information and ending just before the “field of the invention” text or “description” delimiter. Moreover, such formats may change over time as when the USPTO may update the format in which patents are displayed, and thus the heuristics for determining document sections would then also be updated accordingly.

One skilled in the art will readily recognize that other indicators may be used for identifying the specification and claims sections, such as looking for claim numbers in the claim sections, and to check that the present application is not limited by that disclosed herein.

In step 520, specification terms and claim terms are identified in the specification and claims. As one skilled in the patent arts will understand, specification terms (also referred to as specification elements) and claim terms (also referred to as claim elements) represent elements in the specification and claims respectively used to denote structural components, functional components, and process components or attributes of an invention. In one example, a sentence in a patent specification stating “the connector 12 is attached to the engine crank case 14 of the engine 16” includes specification terms: “connector 12”, “engine crank case 14”, and “engine 16.” In another example, a sentence in the claims “the connector connected to an engine crank case of an engine” includes claim terms: “connector”, “engine crank case”, and “engine.” One skilled in the art will readily recognize the numerous variations of the above described examples.

In one example, server/processor 210 looks for specification terms by searching for words in the specification located between markers. In an example, an element number and the most previous preceding determiner is used to identify the beginning and end of the specification term. In one example, the end marker is an element number and the beginning marker is a determiner. As will be understood, a determiner as used herein is the grammatical term represented by words such as: a, an, the, said, in, on, out . . . . One skilled in the art will readily know and understand the full listing of available determiners and all determiners are contemplated in the present examples. For example, in the sentence “the connector 12 is attached to the engine crank case 14 of the engine 16”, the element numbers are 12, 14 and 16. The determiners before each element number are respectively “the . . . 12”, “the . . . 14”, and “the . . . 16.” The specification terms are “respectively “connector”, “engine crank case”, and “engine.” In the preceding sentence, the words “is” and “to” are also determiners. However, because they are not the most recent determiners preceding an element number, in the present example, they are not used to define the start of a specification term.

Server/processor 210, in an example, identifies specification terms and records each location of each specification term in the patent or application (for example by page and line number, paragraph number, column and line number, etc.), each specification term itself, each preceding determiner, and each element number (12, 14 or 16 in the above example) in a database.

In another example, the specification terms are identified by using a noun identification algorithm, such as, for example, that entitled Statistical Parsing of English Sentences by Richard Northedge located at “http://www.codeproject.com/csharp/englishparsing.asp”, the entirety of which is hereby incorporated by reference. In the presently described example, server/processor 210 employs the algorithm to identify strings of adjacent nouns, noun phrases, adverbs and adjectives that define each element. Thereby, the markers of the specification term are the start and end of the noun phrase. Identification of nouns, noun phrases, adverbs and adjectives may also come from repositories (e.g., a database) that contain information relating to terms of art for the particular type of document being analyzed. For example, where a patent application is being analyzed, certain patent terms of art may be used (e.g., sealingly, thereto, thereupon, therefrom, etc.) for identification. The repository of terms-of-art may be developed by inputting manually the words or by statistical analysis of a number of documents (e.g., statistical analysis of patent documents) to populate the repository with terms-of-art. Moreover, depending upon a classification or sub-classification for a particular document, the terms of art may be derived from analyzing the other patent documents within a class or sub-class (see also the USPTO “Handbook of Classification” found at “http://www.uspto.gov/web/offices/opc/documents/handbook.pdf”, the entirety of which is hereby incorporated by reference).

Alternatively, server/processor 210 may use the element number as the end marker after the specification term and may use the start of the noun phrase as the marker before the specification term. For example, the string “the upper red connector” would include the noun “connector” adjectives “red” and “upper.” Server/processor, in an example, records the words before the marker, the location of the specification term, the term itself, and any element number after the specification term (if one exists).

In an example for identifying the claim terms, server/processor 210 first determines claim dependency. Claim dependency is defined according to its understanding in the patent arts. In one example, the claim dependency is determined by server/processor 210 by first finding the claim numbers in the claims. Paragraphs in the claim section starting with a number are identified as the start of a claim. Each claim continues until the start of the next claim is identified.

The claim from which a claim depends is then identified by finding the words “claim” followed by a number in the first sentence after the claim number. The number following the word “claim” is the claim from which the current claim depends. If there is no word “claim”, then the claim is deemed an independent claim. For example, in the claim “2. The engine according to claim 1, comprising . . . ”, the first number of the paragraph is “2”, and the number after the word “claim” is “1”. Therefore, the claim number is 2 and the dependency of the claim terms in claim 2 depend from claim 1. Likewise, the dependency of the claim terms within claim 2 is in accordance with their order. For example, where the term “engine” is found twice in claim 2, server/processor 210 assigns the second occurrence of the term to depend from the first occurrence.

The claim terms are identified by employing a grammar algorithm such as that described above to identify the markers of a noun clause. For example, in the claim “a connector attached to an engine crank case in an engine”, the claim terms would constitute: connector, engine crank case, and engine. In another example, the claim terms are identified by looking to the determiners surrounding each claim term as markers. In an example, the claim term, its location in the claims (such as by claim number and a line number), and its dependency are recorded by server/processor 210. Thus, the algorithm will record each claim term such as “connector”, whether it is the first or a depending occurrence of the term, the preceding word (for example “a”) and in what claim and at what line number each is located.

In step 530, information processed related to the specification terms and claim terms is delivered in any format to user 220. The processed output may be delivered in a separate document (e.g., a Word® document, a spreadsheet, a text file, a PDF file, etc.) and it may be added or overlaid with the original document (e.g., in the form of a marked-up version, a commented version (e.g., using Word® commenting feature, or overlaid text in a PDF file). The delivery methods may be, for example, via e-mail, a web-page allowing user 220 to download the files or reports, a secure FTP site, etc.

Referring now to FIG. 6, an example of a process 600 for identifying errors in the specification and claims is described. In step 610, server/processor 210 processes and analyzes the specification terms and claim terms output by step 530 (see FIG. 5). Server/processor 210 compares the specification terms to see whether any of the same specification terms, for example “connector”, includes different element numbers. If so, then one version may be correct while the other version is incorrect. Therefore, server/processor 210 determines which version of the specification term occurs more frequently in the specification to determine which of the ambiguously-used specification terms is correct.

In step 620, server/processor 210 outputs an error/warning for the term and associated element number having the least number of occurrences, such as “incorrect element number.” For example, if the specification term “connector 12” is found in the specification three times and the term “connector 14” is found once, then for the term “connector 14”, an error will be output for the term “connector 14.” The error may also include helpful information to correct the error such as “connector 14 may mislabeled connector 12 that is first defined at page 9, line 9 of paragraph 9”.

In another example, server processor 210 looks to see whether the same element number is associated with different specification terms in step 610. If so, then one version may be correct while the other version is incorrect. Therefore, server/processor 210 determines which version of the specification term occurs more frequently in the specification. Then, in step 620, server/processor 210 outputs an error for the term and associated element number having the least number of occurrences, such as “incorrect specification element.” For example, if the term “connector 12” is found in the specification three times and the term “carriage 12” is found once, then an appropriate error statement is output for the term “carriage 12.”

In another example, server/processor 210 looks to see whether proper antecedent basis is found for the specification terms in step 610. As stated previously, server/processor 210 records the determiners or words preceding the specification elements. In step 610, server/processor 210 reviews those words in order of their occurrence and determines whether proper antecedent basis exists based on the term's location in the specification. For example, the first occurrence of the term “connector 12” is reviewed to see if it includes the term “a” or “an.” If not, then an error statement is output for the term at that particular location. Likewise, subsequent occurrences of a specification term in the specification may be reviewed to ensure that the specification terms include the words “said” or “the.” If not, then an appropriate error response is output in step 620.

In another example, server/processor 210 reviews the claim terms for correct antecedent basis similar to that discussed above in step 610. As stated previously, server/processor 210 records the word before each claim term. Accordingly, in step 610, the claim terms are reviewed to see that the first occurrence of the claim term in accordance with claim dependency (discussed previously herein) uses the appropriate words such as “a” or “an” and the subsequent occurrences in order of dependency include the appropriate terms such as “the” or “said.” If not, then an appropriate error response is output in step 620.

In another example, server/processor 210 in step 610 reviews the specification terms against the claim terms to ensure that all claim terms are supported in the specification. More specifically, in step 610, server/processor 210 records each specification term that has an element number. Server/processor 210 then determines whether any of the claim terms are not found among the set of recorded specification terms. If claim terms are found that are not in the specification, then server/processor 210 outputs an error message for that claim term accordingly. This error may then be used by the user to determine whether that term should be used in the specification or at least defined.

In another example, server/processor 210 identifies specification terms that should be numbered. In step 610, server/processor 210 identifies specification terms without element numbers that match any of the claim terms. In step 620, server/processor 220 outputs an error message for each unnumbered term accordingly. For example, server/processor 210 may iterate through the specification and match claim terms with the sequence of tokens. If a match is found with the series of tokens and no element number is used thereafter, server/processor 210 determines that an element is used without a reference numeral or other identifier (e.g., a symbol).

In another example, specification terms or claim terms having specific or important meaning are identified. Here, server/processor 210 in step 610 reviews the specification and claims to determine whether words of specific meaning are used in the specification or claims. If so, then in step 620 an error message is output. For example, if the words “must”, “required”, “always”, “critical”, “essential” or other similar words are used in the specification or claims, then a statement is output such as “limiting words are being used in the specification.” Likewise, if the terms “whereby” “means” or other types of words are used in the claims, then a statement describing the implications of such usage is output. Such implications and other such words will be readily understandable to one of skill in the art.

In another example, server/processor 210 looks for differing terms from specification and claim terms that, although different, are correct variations of such specification or claim terms. As stated previously, server/processor 210 records each specification term and claim term. Server/processor 210 compares each of the specification terms. Server/processor 210 also compares each of the claim terms. If server/processor 210 identifies variant forms of the same terms in step 610, then in step 620, server/processor 210 outputs a statement indicating that the variant term may be the same as the main term. In one example, server/processor 210 compares each word of each term, starting from the end marker and working toward the beginning marker, to see if there is a match in such words or element numbers. If there is a match and the number of words between markers for the subsequently occurring term is shorter than its first occurrence, then a statement for the subsequently occurring term is output. For example, where the first occurrence in the specification of the term is “electrical connector 12” and a second occurrence in the specification of a term is “connector 12”, this second occurrence of the specification term “connector” is determined by server/processor 210 as one of the occurrences of the specification term “electrical connector 12.” Accordingly, for the term “connector 12”, server/processor 210 outputs “this is the same term as upper connector 12.” Other similar variations of terms that are consistent with Patent Office practice and procedure are also reviewed.

Where a specification or claim term includes two different modifiers and a subsequent term is truncated, then server/processor 210 outputs “clear to which prior term this term refers” in step 610. For example, where the terms “upper connector” and “lower connector” are used and a subsequent term “connector” is also used, then the process outputs an appropriate error response in step 620 for the term “connector.”

In the instance where a term is not identified as a subset term, then in an example, it is output as a new term. For example, if the first occurrence of a specification term is “upper connector 12” and “lower connector 12”, then the term “upper connector 12” will be output. “Lower connector 12” will also be output as a different element at different locations in the specification.

It will be understood that the application is not limited to the specific responses as referenced above, and that any suitable output is contemplated in accordance with the invention including automatically making the appropriate correction. If no errors are found, then the process ends at step 630.

Referring now to FIG. 7, an example for processing drawing information 700 is shown and described. As will be understood by one skilled in the patent arts, patents include associated sheets of drawings, wherein each sheet may have one or more figures thereon. The figures themselves are the actual physical drawing of the device or process or other feature for each figure number. The figure numbers are numbers that identify the figure (for example figure “1”), while element numbers typically point to specific elements (“24”) on the figure. In step 710, drawing information may be uploaded by a user 220 or retrieved from a repository by server/processor 210 as discussed previously. Server/processor 210 may, in an example, identify the information as drawing information by either reading user input identifying the drawing as such, by recognizing the file type as a PDF or other drawing file, or other known means.

In step 720, server/processor 210 processes the drawing information to extract figure numbers and element numbers. In an example, an optical character recognition OCR algorithm is employed by server/processor 210 to read the written information on the drawings. The OCR algorithm searches for numbers, in an example, no greater than three digits, which have no digits separated by punctuation such as commas, and of a certain size to ensure the numbers are element numbers or figure numbers and not other numbers on drawing sheets such as patent or patent application numbers (which contain commas) or parts of the figures themselves. One skilled in the art will readily recognize that other features may be used to distinguish element numbers from background noise or other information, such as patent numbers, titles, the actual figures or other information. This example is not limited by the examples set forth herein.

When searching for the figure numbers, server/processor 210 may use an OCR algorithm to look for the words “Fig. 1”, “FIG. 1”, “Figure 1” or other suitable word representing the term “figure” in the drawings (hereinafter “figure identifier”). The OCR algorithm records the associated figure number, such as 1, 2 etc. For example, “FIG. 1” has a figure identifier “FIG. 1” and a figure number “1.” In addition to identifying the figure identifier, server/processor 210 obtains the X-Y location of the figure identifier and element numbers. It is understood that such an OCR heuristic may be tuned for different search purposes. For example, the figure number may include the word “FIGURE” in an odd font or font size, which may also be underlined and bold, otherwise unacceptable for element numbers or used in the specification.

In an example, server/processor 210 in step 720 first determines the number of occurrences of the figure identifier on a sheet. If the number of occurrences is more than one on a particular sheet, then the sheet is deemed to contain more than one figure. In this case, server/processor 210 identifies each figure and the element numbers and figure number associated therewith. To accomplish this, in one example, a location of the outermost perimeter is identified for each figure. The outer perimeter is identified by starting from the outermost border of the sheet and working in to find a continuous outermost set of connected points or lines which form the outer most boundary of a figure.

In another example, a distribution of lines and points that are not element numbers or figure identifiers is obtained. This information (background pixels not related to element numbers or figure identifiers) is plotted according to the X/Y locations of such information on the sheet to thereby allow server/processor 210 to determine general locations of background noise (e.g., pixels which are considered “background noise” to the OCR method) and therefore, form the basic regions of the figures. Server/processor 210 then identifies lines extending from each element number by looking for lines or arrows having ends located close to the element numbers. Server/processor 210 then determines to which figure the lines or arrows extend.

Additionally, server/processor 210 determines a magnitude of each element's distance from the closest figure relative to the next closest figure. If the order of magnitude provides a degree of accuracy that the element number is associated with a figure (for example, if element “24” is five times closer to a particular figure than the next closest figure), then that element number will be deemed to be associated with the closest figure. Thereby, each of the element numbers is associated with the figure to which it points or is closest to, or both. In other examples, server/processor 210 may find a line extending from an element number and follows the line to a particular figure boundary (as explained above) to assign the element number as being shown in the particular figure.

The figure identifiers are then associated with the figures by determining where each figure identifier is located relative to the actual figures (e.g., the proximity of a figure identifier relative to the periphery of a figure). One example is to rank each figure number with the distance to each figure periphery. For example, figure identifier “Figure 1” may be 5 pixels from the periphery of a first undetermined figure and 200 pixels from a second undetermined figure. In this case, the heuristic orders the distances for “Figure 1” with the first undetermined figure and then the second undetermined figure. When each of the figure identifiers is ordered with the undetermined figure, the heuristic may identify each figure identifier with the closest undetermined figure. Moreover, where there is sufficient ambiguity between undetermined figures and figure identifiers (e.g., the distances of more than one figure identifier are below a predetermined threshold of 20 pixels), then a warning may be reported to the user that the figure identifiers are ambiguous.

In another example, where more than one figure number is assigned to the same figure and other figures have not been assigned a figure number, the system will modify the search heuristic to further identify the correct figure numbers and figures. An example is shown in FIG. 7A, where two figures are close together vertically on a sheet 780. A first figure identifier is at the top of a first figure and a second figure number is between them. The heuristic may determine that the top figure has a figure number on the top and the bottom figure should be assigned the figure number between them. In this case, the second figure number may be an equal distance from the first and second figure, but it is clear that the second figure number (between the first and second figures) should be assigned to the second figure.

When the initial drawing processing is complete, e.g. from step 720, the drawing processing is checked for errors and/or ambiguities in step 730. For example, it may be determined whether there are figure peripheries that do not have figure identifiers associated with them. In another example, it may be determined whether there are any ambiguous figure identifiers (e.g., figure identifier below a proximity threshold more than one figure periphery). In another example, if the magnitude/distance of a figure identifier to a figure periphery is not within a margin of error (for example if “figure 1” is less than five times closer to its closest figure than the next closest figure), the process continues where additional processing occurs to disambiguate the figure identifiers and figures (as discussed below in detail with respect to steps 740-750).

If no errors occur in figure processing, control proceeds to step 760. Otherwise, if drawing errors have been detected, the process continues with step 740. At step 760, the process checks whether each drawing sheet has been processed. If all drawings have been processed, control proceeds to step 770. Otherwise, the process repeats at step 710 until each drawing sheet has been processed.

In step 770, when the drawing analysis is delivered, the heuristic transitively associates each figure number of its figure identifier with the element numbers through its common figure (e.g., FIG. 1 includes elements 10, 12, 14 . . . ).

With reference to step 740, additional processing is employed to create a greater confidence in the assignment of a figure number by determining whether some logical scheme can be identified to assist with correctly associating figures with figure identifiers. For example, in step 740, server/processor 210 determines whether the figures are oriented vertically from top to bottom on the page and whether the figure identifier is consistently located below the figures. If so, then server/processor 210 associates each figure identifier and number with the figure located directly above. Similarly, server/processor 210 may look for any other patterns of consistency between the location of the figure identifier and the location of the actual figure. For example, if the figure identifier is consistently located to the left of all figures, then server/processor 210 associates each figure with the figure identifier to its left.

In another example, in step 740, server/processor 210 identifies paragraphs in the specification that began with the sentence having the term “figure 1”, “fig. 2” or other term indicating reference to a figure in the sentence (hereinafter “specification figure identifier”). Server/processor 210 then looks for the next specification figure identifier. If the next specification figure identifier does not occur until the next paragraph, server/processor 210 then identifies the element numbers in its paragraph and associates those element numbers with that specification figure identifier. If the next specification figure identifier does not occur until a later paragraph, server/processor 210 identifies each element number in every paragraph before the next specification figure identifier. If the next specification figure identifier occurs in the same paragraph, server/processor 210 uses the element numbers from its paragraph. This process is repeated for each specification figure identifier occurring in the first sentence of a paragraph. As a result, groups of specification figure identifiers are grouped with sets of specification numbers.

In step 744, the figure numbers associated with the element numbers in the actual figures (see step 720) are then compared with the sets of specification figure identifiers and their associated element numbers. In step 746, if the specification figure identifier and its associated element numbers substantially match the figure identifier and its associated element numbers in the drawings (for example, more than 80% match), then step 748 outputs the figure identifier and its associated elements as determined in step 720. If not and if the specification figure identifier and its associated element numbers substantially match the next closest figure identifier and its associated element numbers in the drawings, then step 750 changes the figure number obtained in step 720 to this next closest figure number.

For example, the first sentence in a paragraph contains “FIG. 1” and that paragraph contains element numbers 12, 14 and 16. The specification figure identifier is FIG. 1, the figure number is “1” and the element numbers are 12, 14 and 16. A figure number on a sheet of drawings is determined to be FIG. 2 in step 720 and associated with element numbers 12, 14 and 16. Likewise, FIG. 1 on the sheet of drawings is determined to contain elements 8, 10 and 12 in step 720. Furthermore, steps 720 and 730 determined that FIG. 1 and FIG. 2 are located on the same sheet and that there is an unacceptable margin of error as to which figure is associated with which figure number, and therefore, which element numbers are associated with which figure number. Here, server/processor 210 in step 746 determines that “figure 2” should be actually be “figure 1” as “figure 1” has the elements 12, 14 and 16. Therefore, in step 750, the figure number “2” is changed to the figure number “1” in the analysis of steps 720 and output in accordance therewith in the same manner as that for step 748. As will be described hereinafter, the output information related to the figure numbers and specification numbers can be used to extract information related to which figures are associated with what elements and to identify errors.

Alternatively, where two ambiguous figures include the same element number, but one of the two ambiguous figures also includes an element not present in the other, processor/server 210 may match figure numbers based on the specification figure identifiers and their respective element numbers. For example, a first ambiguous figure includes element numbers 10, 12, and 14. A second ambiguous figure includes element numbers 10, 12, 14, and 20. Server/processor 210 then compares specification figure identifiers and their respective element numbers with the element numbers of first ambiguous figure and second ambiguous figure. In this way, server/processor 210 can match second ambiguous figure with the appropriate specification figure identifier.

Referring now to FIG. 8, another example for a process flow 800 is shown for identifying specification and drawing errors is described. In step 810, server/processor 210 identifies the specification figure identifier in the first sentence of any paragraph and associates elements as previously discussed herein. In step 820, server/processor 210 then reviews each figure number and element number in the drawings to determine whether element numbers in the specification are found in the correct drawings. If not, then an appropriate error is output in step 830. For example, where a paragraph in the specification begins with a specification figure identifier “FIG. 1” and its paragraph contains elements 12, 14 and 16, FIG. 1 in the drawings is reviewed to determine whether each of those element numbers are found in FIG. 1 in the drawings. If not, then an error is output stating such.

In FIG. 9, a process flow 900 shows an example of how server/processor 210 processes outputs from FIGS. 5 and 6 to associate the specification terms, claim terms and drawing element numbers in step 910. For example, information from steps 530 and 670 relating to specification terms, element numbers, claim terms and drawing element numbers, figures and locations are matched up. In step 920, server/processor 210 outputs results to the user 220 as shown in FIG. 10 or for further processing.

In one example, all of the information generated by the process of FIG. 9 is output as shown in FIG. 10. For example, the element “connector” is shown having the term “connector” with an element number 12. The location in the specification of this specification term is at page 2, line 32. Its location in the claims is at claim 1, line 4. This information was generated through the process discussed in connection with FIG. 7. The element number 12 is located in FIGS. 1 and 3 as was obtained in connection with the process of figure B3.

Additionally, server/processor 210 outputs errors under the column entitled “error or comment” in FIG. 10. By way of example, for the term “connector” located at page 3, line 18, the listing in FIG. 10 instructs the user 220 that the specification term lacks antecedent basis. Similarly, for the term “upper connector”, an error is output stating that the term may be an incorrect specification term. Likewise, for the term “cable”, an error is output stating that the term is not found in the claims and that there is no corresponding element number “16” in the drawings. Upper connector 12 is determined that it should be in FIG. 4, but is not as determined by the process of FIG. 8. The processing described in figures B14 and B12, in one example, was used to identify such errors.

Referring now to FIG. 11, another example shown by process 1100 is shown and described. The process starts at step 530 where the specification terms and claim terms are output. In step 1110, server/processor 210 obtains a prosecution history from the user 220, patent repositories 240, 242, 244, or other sources. In step 1120, server/processor 210 then conducts a search through the prosecution history for specification terms and claim terms. In one example, server/processor 210 conducts this search based on specification terms and claim terms requested by the user 220. For example, the user 220 is prompted by the output as shown in FIG. 10 to select certain terms in the left-hand most column of which a user is interested. In response, server/processor 210 conducts a search through the prosecution history, finds the terms in the prosecution history, and extracts language related to the term.

In one example, server/processor 210 records the location of the term in the prosecution history and lists its location in FIG. 10 under the title “pros history” as shown therein. In another example, server/processor 210 retrieves language around each occurrence of the identified term from the prosecution history three sentences before the occurrence of the term and three sentences after the occurrence of the term. As a result, user 220 retrieves the specific language relating to that term and the processed results are output at step 1130.

Other examples including prosecution history analysis may include the presenting the user with a report detailing the changes to the claims, and when they occurred. For example, a chart may be created showing the claims as-filed, each amendment, and the final or current version of the claims. The arguments from each response or paper filed by the applicant may also be included in the report allowing the user to quickly identify potential prosecution history estoppel issues.

Another example, may include the Examiner's comments (e.g., rejections or objections), the art cited against each claim, the claim amendments, and the Applicant's arguments. In another example, the Applicant's amendments to the specification may be detailed to show the possibility of new matter additions.

In another example, as shown by process 1200 in FIG. 12, server/processor 210 in step 1210 conducts a search (e.g., a search of the Internet by way of a search engine) in an attempt to identify web pages that employ or use the terms output from step 530. Such a search, for example, may identify web pages that use the specification terms and claim terms. Server/processor 210 may employ a statistical processing scheme to determine search terms based on words (and their relation to each other) as used in a patent document. In step 1220, server/processor 210 outputs the results to user 220 as shown in FIG. 14 next to the statement “web site with possible similar technology.”

As shown in FIG. 13, another example includes a process 1300 where server/processor 210 receives the specification terms and claim terms from step 530. In step 1310, server/processor 210 conducts a search through the classifications index, such as that associated with the United States Patent and Trademark Office and estimates the class and subclass based on the occurrence of specification terms and claim terms in the title of the classification. In one example, as shown in FIG. 14, server/processor 210 outputs the class and subclass as shown next to the title “prior art classifications.” Again, as will be described in greater detail, a statistical processing method may be employed to conduct the search with greater accuracy. In step 1320, server/processor 210 then conducts a search through patent databases, such as those maintained by the United States Patent and Trademark Office, based on the class and subclass estimated in step B256 and the specification terms and claim terms. Again, a statistical processing method may be employed to increase the accuracy as will be described. In step 1330, server/processor 210 then outputs the results to the user 220 as shown, for example, in FIG. 14 next to the title “relevant patents.”

Referring now to FIG. 15, another example includes a process flow 1500 where server/processor 210 employs a translation program to allow for searching of foreign patent databases. For example, the process starts where server/processor 210 receives the specification terms and claim terms from step 530 (see FIG. 5). In step 1510, server/processor 210 then translates them into a foreign language, such as for example, Japanese.

In step 1520, foreign patent databases are searched similar to that described above.

In step 1530, the results of the search are then translated back into a desired language.

In step 1540, the results are output to the user 220.

As referenced above, a statistical processing method may be employed in any of the above searching strategies based on the specification terms, claim terms, or other information. More specifically, in one example, specification terms or claim terms are given particular weights for searching. For example, terms found in both the independent claims and as numbered specification terms of the source application are given a relatively higher weight. Likewise, specification terms having element numbers that are found in the specification more than a certain number of times or specification terms found in the specification with the most frequency are given a higher weight. In response, identification of the higher weighted terms in the searched classification title or patents is given greater relevance than the identification of lesser weighted terms.

Referring now to FIG. 16, another example includes a process flow 1600 where server/processor 210 employs heuristics to generate claims that include specification element numbers (e.g., per some foreign patent practices). Server/processor 210 receives the specification terms and claim terms from step 530 (see FIG. 5). In step 1610, the claim terms are reviewed to determine which claim terms match specification terms that have element numbers. In step 1620, server/processor 210 inserts the element numbers to the claim terms such that the claim terms are numbered (e.g., claim element “engine” becomes “engine (10)”). In step 1630, the numbered claim terms are output to the user 220 in a suitable format such as a text file of the numbered claims.

Referring now to FIG. 17, another example includes a process flow 1700 where server/processor 210 generates a summary and an abstract from the claims. The process starts at step 1710 where the independent claims are converted into sentence structured claims. This is accomplished by removing semicolons and replacing with periods and other suitable grammar substitutions. In step 1720, server/processor 210 replaces legal terms such as “said” and “comprising” with non-legal words such as respectively “the” and “including.” In step 1730, server/processor 210 strings the independent claims, now in sentence structure, together to form paragraphs in order of dependency. In step 1740, the paragraph structured independent claims are then linked into the summary and in step 1742, the summary's output to the user 220. In step 1750, server/processor 210 extracts the first independent claim for the summary (as that practice is understood by one skilled in the patent arts). In step 1752, server/processor 210 conducts a word count to insure that a number of words in the summary do not exceed the number allowed by the appropriate patent offices. In step 1754, server/processor 210 outputs the abstract and, if found, word number error to the user 220.

Referring now to FIG. 18, another example includes a process 1800 to output drawings for the user that include the element number and specification element name. Process 1800 may be run as a standalone process or it may further process results from step 920 (of FIG. 9) to achieve an output that merges the specification element names with the figures. The results are used to process the drawings with the specification and claim terms delivered from step 530 of FIG. 5. In one example, the specification terms having numbers that match the element numbers on the drawing sheets are listed on the drawings next to those element numbers. For example, the specification terms can be listed long the left-hand column of the drawings next to each figure number where the element numbers may be found. Alternatively, the specification terms are listed immediately next to the element numbers (e.g., element “10” in the figures may be converted to “10—engine” which defines the name of the specification term immediately after the reference numeral in the figure). In step 1810, server/processor 210 locates each element number used in the figure and searches for that element number in the specification output. Server/processor 210 then associates each particular element number with a specification element name. At step 1820, the drawings are output by server/processor 210 to the user 220, which may include, for example, a listing of element numbers and element names, or an element name next to each element number in the figures.

FIG. 19 shows an OCR process 1900 adapted to reading patent drawings and figures. In step 1910, patent figures or drawings are retrieved in a graphical format. For example, the patent figures or drawings may be in PDF or Tiff file formats. Next, in step 1914, OCR is performed and location information is recorded for each character or symbol recognized as well as OCR error position information. For example, the location information may be X/Y coordinates for each character start as well as the X/Y coordinates that define the boundaries of each character.

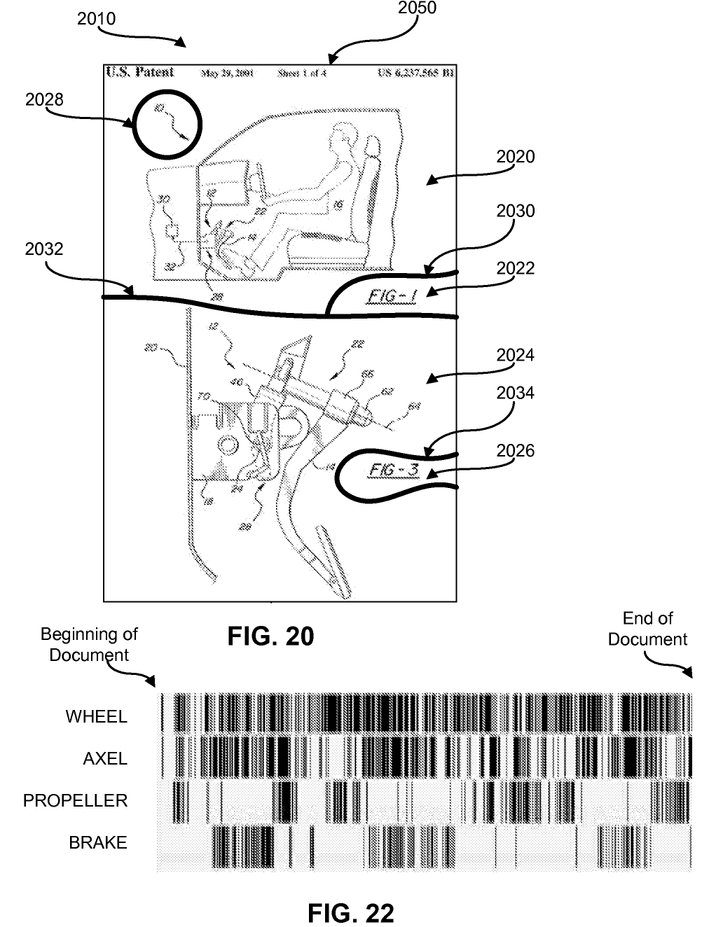

In step 1920, the graphical figures are subdivided into regions of non-contacting graphics. For example, FIG. 20 includes an exemplary patent drawing page 2010 that includes multiple non-contacting regions. A first region 2020 generally includes the graphics for “FIG-1”. A second region 2022 includes the text identifier for “FIG-1”. First region 2020 and second region 2022 are separated by a first delimiting line 2030 and a second delimiting line 2032. Second delimiting line 2032 further separates first region 2022 from a third region 2024 that includes the graphics for “FIG-3”. A third delimiting line 2034 surrounds fourth region 2026 that contains the text identifier for “FIG-3” and further separates third region 2024 from fourth region 2026.

In addition to region detection, the OCR heuristic may identify lead lines with or without arrows. As shown in FIG. 20, an element number “10” with a lead line is captured within a fifth region 2028.

In step 1924, the top edge of the drawing 2050 is segmented from the rest of the drawing sheet which may contain patent information such as the patent number (or publication number), date, drawing sheet numbering, etc.

In step 1930, an initial determination of the graphical figure location is made and position information is recorded for each, for example, where a large number of OCR errors are found (e.g., figures will not be recognized by the OCR algorithm and will generate an error signal for that position). The X/Y locations of the errors are then recorded to generally assemble a map (e.g., a map of graphical blobs) of the figures given their positional locations (e.g., X/Y groupings). In a manner similar to a scatter-plot, groupings of OCR errors may be used to determine the bulk or center location of a figure. This figure position data is then used with other heuristics discussed herein to correlate figure numbers and element numbers to the appropriate graphical figure.

In step 1934, an initial determination of the figure numbers, as associated with a graphical figure, is performed. For example, the proximity of an OCR recognized “FIG. 1”, “Figure 1”, “FIG-1”, etc. are correlated with the closest figure by a nearest neighbor algorithm (or other algorithm as discussed above). Once the first iteration is performed, other information may be brought to bear on the issue of resolving the figure number for each graphical blob.

In step 1940, an initial determination of element numbers within the graphical figure locations is performed. For example, each element number (e.g., 10, 20, 22, n) is associated with the appropriate graphical figure blob by a nearest neighbor method. Where some element numbers are outside the graphical figure blob region, the lead lines from the element number to a particular figure are used to indicate which graphical blob is appropriate. As shown by region 2028, the element number “10” has a lead line that goes to the graphical region for FIG. 1.

In step 1944, the figure numbers are correlated with the graphical figure locations (e.g., FIG. 1 is associated with the graphical blob pointed to in region 2020).

In step 1950, the element numbers are correlated with the graphical figure locations (e.g., elements 10, 12, 14, 16, 22, 28, 30, 32 are with the graphical blob pointed to in region 2020).

In step 1954, the element numbers are correlated with the figure numbers using the prior correlations of steps 1944, 1950 (e.g., element 30 is with FIG. 1).

This process may proceed with each page until complete. Moreover, disambiguation of figure numbers and element numbers may proceed in a manner as described above with regard to searching the specification for element numbers that appear with particular figure numbers to further refine the analysis.

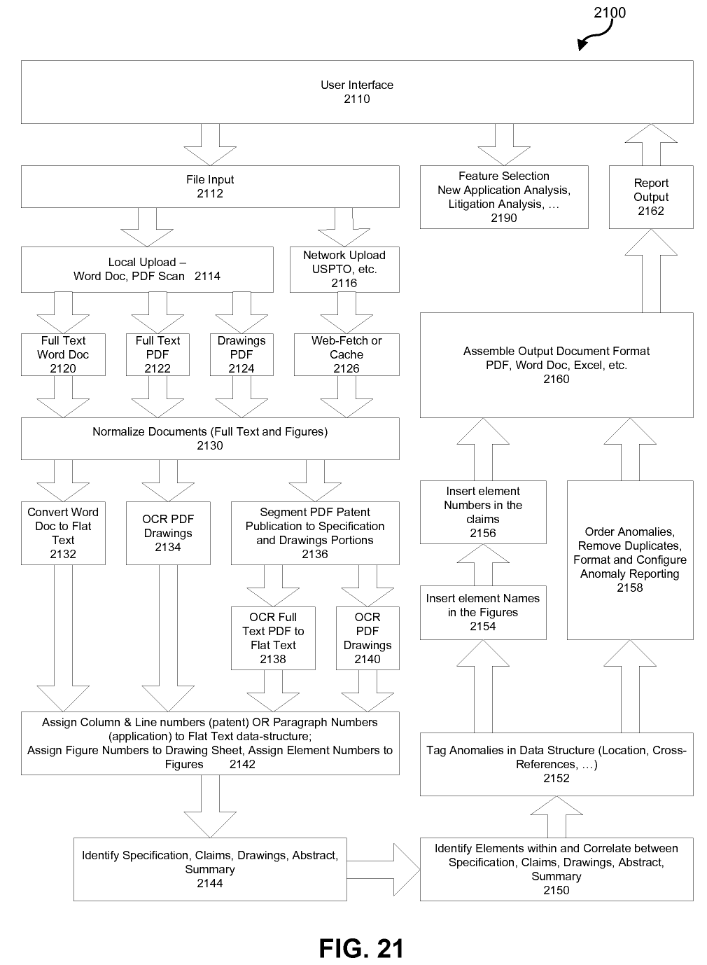

FIG. 21 is a functional flow diagram 2100 of a document analysis system for use with the methods and systems described herein. Block 2110 described a user interface that may be a network interface (e.g., for use over a network such as the Internet) or a local program interface (e.g., a program that operates on the Windows® operating system). User 220 may use a feature selection process 2190 to identify to the system what type of analysis is requested (e.g., application filing, litigation, etc.) for the particular documents identified (e.g., new patent application, published application, issued patent). In block 2112, the user inputs files or document identifiers. Local upload block 2114 allows user 220 to provide the files directly to the system, for example through an HTTPS interface from a local computer or a local network. When user 220 identifies a file, rather than uploading it directly, the system will search out the file to download through a network upload protocol 2116. In an example where user 220 identifies a patent or a published patent application, the system will locate the appropriate files from a repository (e.g., the USPTO). In block 2126, the system will fetch the files via the network or may also load the files from a cache (e.g., a local disk or networked repository).

In blocks 2120, 2122, 2124 the full text (e.g., a Word® document) is uploaded, a PDF file is uploaded, and PDF drawings are uploaded. It is understood that other document forms may be utilized other than those specified herein.

In step 2130, the files are normalized to a standard format for processing. For example, a Word® document may be converted to flat-text, the PDF files may be OCRed to provide flat text, etc., as shown by blocks 2132, 2134. In block 2136, document types such as a patent publication etc., may be segmented into different portions so that the full-text portion may be OCRed (as in step 2138) and the drawings may be OCRed (as in step 2140) using different methods tailored to the particular nature of each section. For example, the drawings may use a text/graphics separation method to identify figure numbers and element numbers in the drawings that would otherwise confuse a standard OCR method.

For example, the text/graphics is provided by an OCR system that is optimized to detect numbers, words and/or letters in a cluttered image space, such as, for example, that entitled “Text/Graphics Separation Revisited” by Karl Tombre et al. located at “http://www.loria.fr/˜tombre/tombre-das02.pdf”, the entirety of which is hereby incorporated by reference. In another example, separation of textual parts from graphical parts in a binarized image is shown and described at “http://www.qgar.org/static.php?demoName=QAtextGraphicsSeparation&demoTitre=Text/graphics%20separation”.

In block 2142, location identifiers may be added as metadata to the normalized files. In an example of an issued patent, the column and line numbers may be added as metadata to the OCR text. In another example, the location of element numbers and figure numbers may be assigned to the figures. It is understood that the location of the information contained in the documents may also be added directly in the OCR method, for example, or at other points in the method.

In block 2144, the portions of the documents analyzed are identified. In the example of a patent document, the specification, claims, drawings, abstract, and summary may be identified and metadata added to identify them.

In block 2150, the elements and element numbers may be identified within the document and may be related between different sections. In the example of a patent document, the element numbers in the specification are related to the element names in the specification and claims. Additionally, the element names may be related to the element numbers in the figures. Also, the figure numbers in the drawings may be related to the figure numbers in the specification. Such relations may be performed for each related term in the document, and for each section in the document.

In block 2152, any anomalies within each section and between sections may be tagged for future reporting to user 220. For example, the anomaly may be tagged in metadata with an anomaly type (e.g., inconsistent element name, inconsistent element number, wrong figure referenced, element number not referenced in the figure, etc.) and also the location of the anomaly in the document (e.g., paragraph number, column, line number, etc.). Moreover, cross-references to the appropriate usage may also be included in metadata (e.g., the first defined element name that would correlate with the anomaly).

Additional processing may occur when, for example, the user selects to have element names identified in the figures and/or element numbers identified in the claims. In block 2154, the element names are inserted or overlaid into the figures. For example, where each element number appears in the figures, the element name is placed near the element number in the figures. Alternatively, the element numbers and names may be added in a table, for example, on the side of the drawing page in which they appear. In block 2156, the element numbers may be added to the claims to simplify the lookup process for user 220 or to format the claims for foreign practice. For example, where the claim reads “said engine is connected to said transmission” the process may insert the claim numbers as “said engine (10) is connected to said transmission (12)”.

When processing is complete, the system may assemble the output (e.g., a reporting of the process findings) for the user which may be in the format of a Word® document, an Excel® spreadsheet, a PDF file, an HTML-based filed, etc.

At block 2162, the output is sent to user 220, for example via e-mail or a secure web-page, etc.

In another example, the system recognizes closed portion of the figures and/or differentiates cross-hatching or shading of each of the figures. In doing so, the system may assign a particular color to the closed portion or the particular cross-hatched elements. Thus, the user is presented with a color-identified figure for easier viewing of the elements.

In another example, the user may wish to identify particular element names, element numbers, and/or figure portions throughout the entire document. When user 220 identifies an element number of interest, the system shows each occurrence of the element number, each occurrence of the element name associated with the element number, each occurrence of the element in the claims, summary, and abstract, and the element as used in the figures. Moreover, the system may also highlight variants of the element name as used in the specification, for example, in a slightly different shade than is used for the other highlights (where color highlighting is used).

In another example, the system may recognize cross-hatching patterns and colorizes the figures based on the cross-hatching patterns and/or closed regions in the figures. Closed regions in the figures are those that are closed by a line and are not open to the background region of the document. Thus, where an element number (with a leader line or an arrow) points to a closed region the system interprets this as an element. Similarly, cross-hatches of matching patterns may be colorized with the same colors. Cross-hatches of different patterns may be colorized in different colors to distinguish them from each other.

In another example, the system may highlight portions of the figures when the user moves a cursor over an element name or element number. Such highlighting may also be performed, for example, when the user is presented with an input box. The user may then input, for example, a “12” or an “engine”. The system then highlights each occurrence in the document including the specification and drawings. Alternatively, the system highlights a drawing portion that the user has moved the cursor over. Additionally, the system determines the element number associated with the highlighted drawing portion and also highlights each of the element numbers, element names, claim terms, etc. that are associate with that highlighted drawing portion.

In another example, an interactive patent file may be configured based on document analysis and text/graphical analysis of the drawings. For example, an interactive graphical document may be presented to the user that initially appears as a standard graphical-based PDF. However, the user may select and copy text that has been overlaid onto the document by using OCR methods as well as reconciling a full-text version of the document (if available). Moreover, on the copy operation the user may also receive the column and line number citation for the selection (which may assist user 220 in preparing, for example, a response to an office action). When the user pastes the selected text into another document, the copied text appears in quotations along with the column/line number, and if desired, the patent's first inventor to identify the reference (e.g., “text” (inventor; col. N, lines N-N)).

In another example, the user may request an enhanced patent document, fore example, in the form of an interactive PDF file. The enhanced patent document may appear at first instance as a typical PDF patent document. Additional functionality, e.g. the enhancements, allow the user to select text out of the document (using the select tool) and copy it. The user may also be provided with a tip (e.g., a bubble over the cursor) that gives then column and line number. Additionally, the user may select or otherwise identify a claim element or a specification element (e.g., by using a double-click) that will highlight and identify other instances in the document (e.g., claims, specification, and drawings).

FIG. 22 shows a word distribution map 2200 which is a graphical indication of word frequency starting from the beginning of a document (or section thereof) and the end of the document and includes the word's position in the document (in a linear document form). Each time the word on the left is mentioned in the text, a bar is indicated with its position in the document. Using such mapping the system can draw inferences as to the relevancy of each word to another (or lack of relevancy).

Examples of inferences drawn from distribution map 2200 include the relevancy of certain specification elements (e.g., “wheel” and “axel”) to each other. The system can readily determine that “wheel” and “axel” are not only discussed frequently throughout the text, but usually together because multiple lines appear in the text in close proximity to each other. Thus, there is a strong correlation between them. Moreover, it appears that “wheel” and “axel” are introduced nearly at the same time (in this example near the beginning of the document) indicating that they may be together part of a larger assembly. This information may be added as metadata to the document for later searching and used as weighting factors to determine relevancy based on search terms.

In another example, the system may determine that “brake” is frequently discussed with “wheel” and “axel”, but not that “wheel” or “axel” is not frequently discussed with “brake”. In another example, the system can determine that “propeller” is not discussed as frequently as “wheel” or “axel”, and that it is usually not discussed in the context of “brake”. E.g., “propeller” and “brake” are substantially mutually exclusive and thus, are not relevant to each other.

Examples of how the systems and methods used herein may be used are described below. For example, a practitioner or lawyer may be interested in particular features at different stages in the life of a document. In this example, a patent application and/or a patent may be analyzed for different purposes for use by user 220. Before filing, for example, user 220 may want to analyze only the patent application documents themselves (including the specification, claims, and drawings) for correctness. However, user 220 may also want to determine if claim terms used have been litigated, or have been interpreted by the Federal Circuit. In another example, a patent document may be analyzed for the purposes of litigation. In other examples, a patent document may be analyzed for the prosecution history. In another example, the patent or patent application may be analyzed for case law or proper patent practice. In another example, the documents may require preparation for foreign practice (e.g., in the PCT). In another example, an automated system to locate prior art may be used before filing (in the case of an application) to allow user 220 to further distinguish the application before filing. Alternatively, a prior art search may be performed to determine possible invalidity issues.

Checking a patent application for consistency and correctness may include a number of methods listed below: C1—Element Names Consistent, C2—Element Numbers Consistent, C3—Spec Elements cross ref to figures, C4—Claim Elements cross ref to figures, C8—Are limiting words present?, C9—Does each claim term have antecedent basis?, C10—Does each claim start with capital, end with period, C11—Is the claim dependency proper, C13—Count words for abstract—warn if over limit, C15—No element numbers in brief description of drawings.

Moreover, reports may be generated including: C5—Insert Element Numbers in claims, C6—Insert Element Names in figures, C7—Report Claim elements/words not in Spec, C12—Count claims (independent, dependent, multiple-dependent), C16—create abstract and summary from independent claims.

Additionally, secondary source analysis may include: C14—Check claim words against a standard dictionary—are any words not found, e.g. sealingly or fixedly that may merit definition in the specification, C17—Inclusions by reference include correct title, inventor, filing date . . . (queried from PTO database to verify), C18—Verify specialty stuff like chemical formulas and/or sequences (reference properly, used consistently).

When analyzing a document for litigation purposes, the above methods may be employed (e.g., C1, C2, C3, C4, C5, C6, C7, C8, C9) and more specialized methods including: L1—Charts for Claim elements and their location in the specification, L3—Was small entity status properly updated? (e.g., an accounting of fees), L4—Is small entity status claims where other patents for same inventor/assignee is large entity?, L5—Cite changes in the final patent specification from the as-filed specification (e.g., new matter additions), L6—Was the filed specification for a continuation etc. exactly the same as the first filed specification? (e.g., new matter added improperly), L7—Does the as-issued abstract follow claim 1? (e.g., was claim 1 amended in prosecution and the abstract never updated?), L8—Do the summary paragraphs follow the claims? (e.g., were the claims amended in prosecution and the summary never updated?), L9—Given a judge's name, have any claim terms come before the judge? any in Markman hearing?, L10—Have any claim terms been analyzed by the Fed. Cir.? (e.g., claim interpretation?)

With regard to prosecution history: H1—Which claims were amended, H2—Show History of claim amendments, concise, and per-claim (cite relevant amendment or paper for each), H3—Show prosecution arguments per claim, e.g. claim 1, prosecution argument 1, prosecution argument 2, etc., as taken from the applicant's responses in the prosecution history, H4—Are the issued claims correct? (e.g., exact in original filing and/or last amendment), H5—Timeline of amendment, H6—Timeline of papers filed, H7—Are all inventors listed in oath/declaration?, H8—Show reference to claim terms or specification in the prosecution history. In other words, how a particular claim term was treated in the prosecution history to provide additional arguments regarding claim construction or interpretation.

With respect to case law: L1—Search for whether the patent been litigated. If so, which cases?, L2—Search for claim language litigated, better if in Markman hearing or Fed Cir opinion, L3—Has certain claim language been construed in MPEP—warning and MPEP citation (e.g. “adapted to” see MPEP 2111.04)

With respect to foreign practice: C5—Insert Element Numbers in claims (e.g., for the PCT), F1—Look for PCT limiting words, F2—Report PCT format discrepancies.

With respect to validity analysis: V1—Is there functional language in apparatus claim?, V2—Are limiting words present?, V3—claim brevity (goes to the likelihood of prior art being available)

With respect to prior art location, keywords & grouped synonyms along with location in sentences, claims, figures (or the document generally) may be used to determine relevant prior art. In an example, a wheel and an axel in the same sentence or paragraph means they are related. A1—Read claims—search classification for same/similar terms, rank by claim terms in context of disclosure

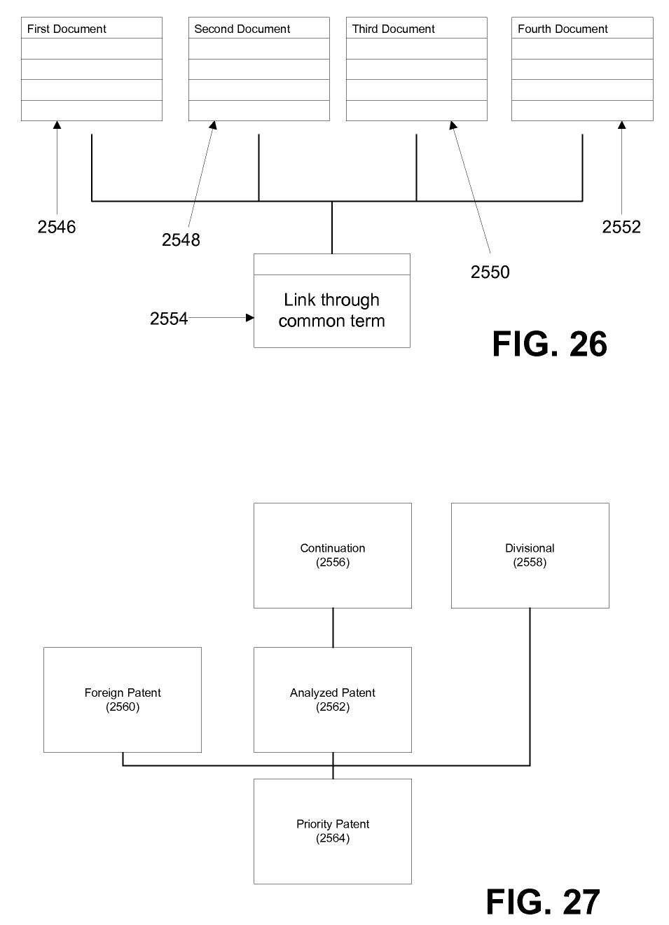

With respect to portfolio management: P1—Generate Family Tree View (use continuity data from USPTO and Foreign databases if requested), P2—Generate Timeline View, P3—Group patents from Assignee/Inventor by Type (e.g., axel vs. brake technology are lumped separately by the claims and class/subclass assigned).

[[GERMANY ADDITIONS]] Referring now to FIG. 26, another example is described. In FIG. 26, a first document 2546, second document 2548, third document 2550, and forth document 2552 are shown being linked through a common identifier 2554. The common identifier may include any alphanumeric or other character or set of characters, drawing, design, word or set of words, a definition or meaning (for example, light bulb in one document and illumination device in another document), or other feature common and unique to at least two of the documents illustrated in FIG. 4. In one example, the common identifier is highlighted in first documents 2546, second document 2548, third document 2550 and forth document 2552. In another example, a master list is provided listing each common identifier. In such example, selecting the common identifier in the master list will cause the common identifier to be highlighted or otherwise identified in each of the first documents 2546, second document 2548, third document 2550 and forth document 2552. In another example, the common identifier is a same word or number or other alphanumeric identifier that is found in each of the documents.

In yet another example, the common identifier in one document, such as first document 2546, is a number while the common identifier in another document, such as second document 2548, is that number combined with a set of alphanumeric characters such as a word. The number, in one example, may be positioned next two or adjacent to the word in the second document 2548, or the number and word may be associated in some other way in the second document 2548. For example, the first document 2546 can be a drawing having a common identifier such as the number “6” pointing to a feature in the drawing, while the second document 2548 is the specification of the patent having the common identifier “connector 6.” This example illustrates that the common identifier need not be identical in both documents and instead should only be related in some unique fashion. Likewise, a common identifier in the first document 2546 may be simply a number pointing to a feature on a drawing while the common identifier in the second document 2548 may also be the same number pointing to a feature in a drawing in the second document. It will also be understood that the present example may be applied to any number of documents. Likewise, the common identifier may link less than all the documents provided. For example, in FIG. 26, only first document 2546 and third document 2550 may be linked through a common identifier, and the remaining documents unlinked. Likewise, the term “link” is given its broadest possible interpretation and includes any form or means of associating or commonly identifying a unique feature among documents. Non-limiting examples of linking will be described in the examples below.

Referring now to FIG. 30, an example of a process for linking common identifiers is shown and described. In FIG. 30, a first document is obtained in step 2566 and a second document is obtained in step 2570. The documents may be obtained through any means, such as those described in the present application including but not limited to the descriptions associated with FIGS. 2, 3, 4, 5 and 7 in the present application.

In steps 2568 and 2572, the document information is processed to find the common identifiers. In one example, one of the documents is a patent, prosecution history or other text based document, and a process such as that described with respect to FIGS. 1-5 and 11 is employed to find common identifiers such as specification terms or claim terms. In another example, where one of the documents is a drawing, the common identifiers may be found by employing the process described with respect to FIGS. 7 and 7A to provide a listing of element numbers. More specifically, the drawings may be processed to identify and provide a listing of element numbers in the drawings, locations of such drawing element numbers, and/or figures associated therewith.

In step 2574, the common identifiers are linked. In one example, the common identifiers are linked as described with respect to (but not limited to) the process described in FIG. 9 of the present application. As shown in FIG. 10, the location of each of the specification terms and claim terms (common identifiers in this example) for each document is provided. For example, the location of connector 6 is shown in the specification, claims, drawing and prosecution history. In such a way, common identifiers such as “connector 6” are linked across the specification, claims and prosecution history of the patent. Likewise, the common identifiers “connectors 6” and “6” are linked across the textual specification, claims and prosecution history and the graphical drawings.

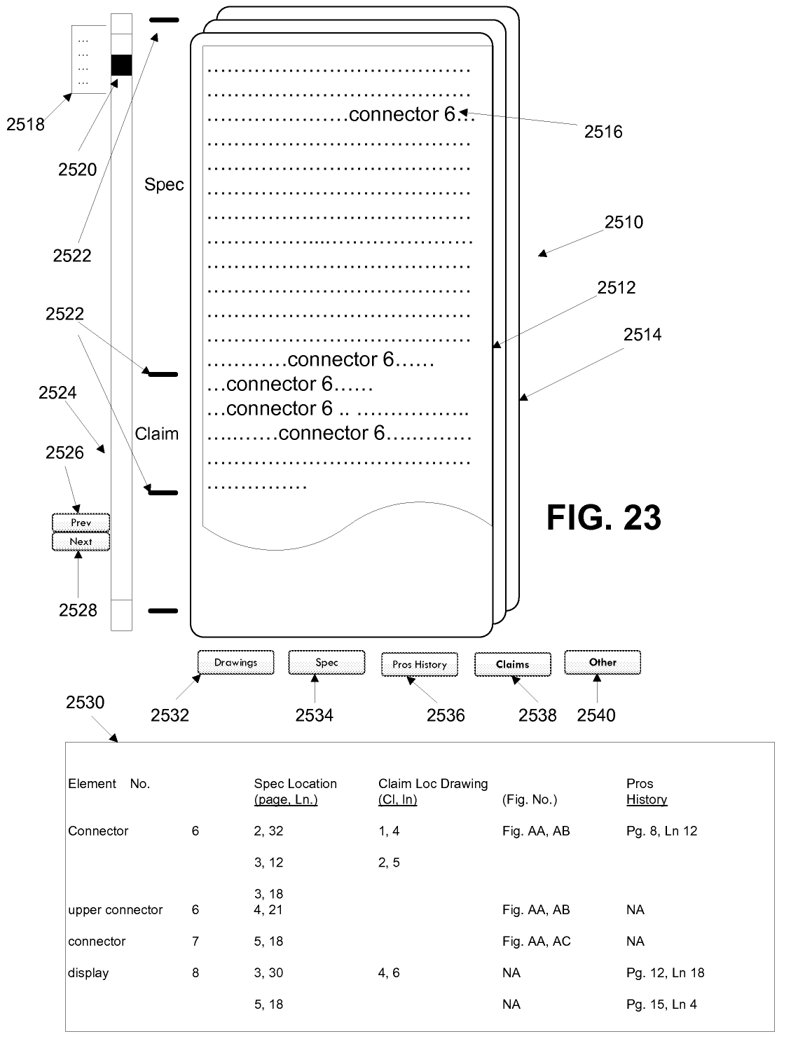

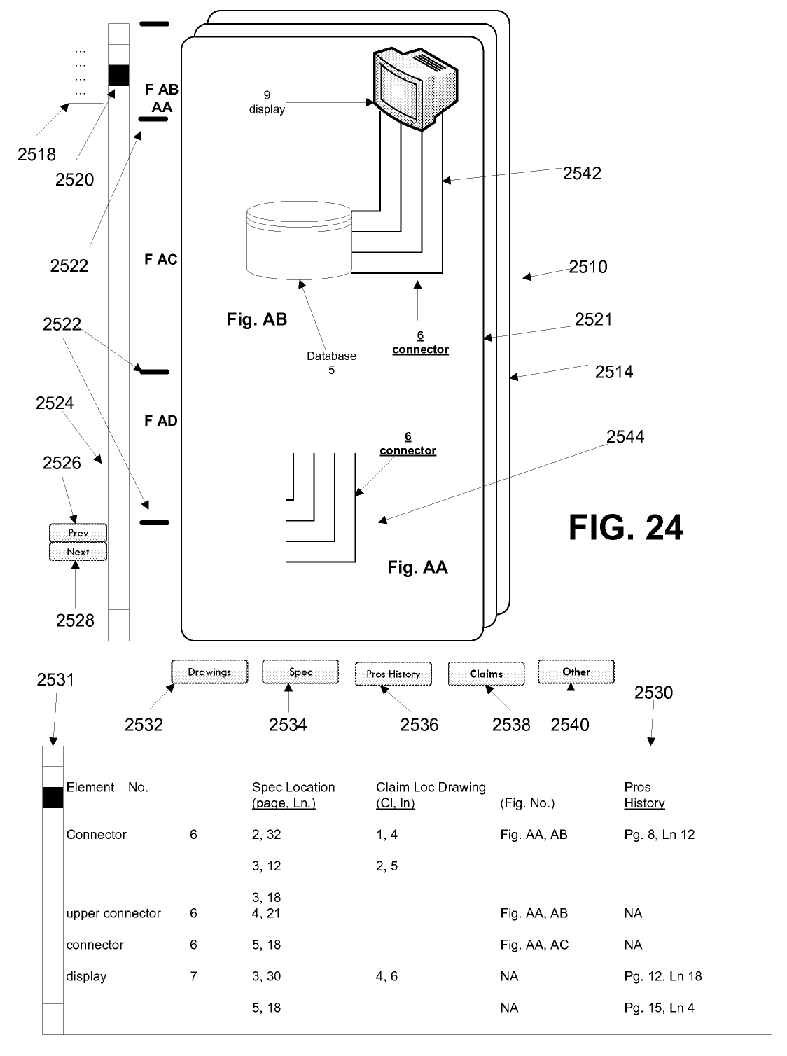

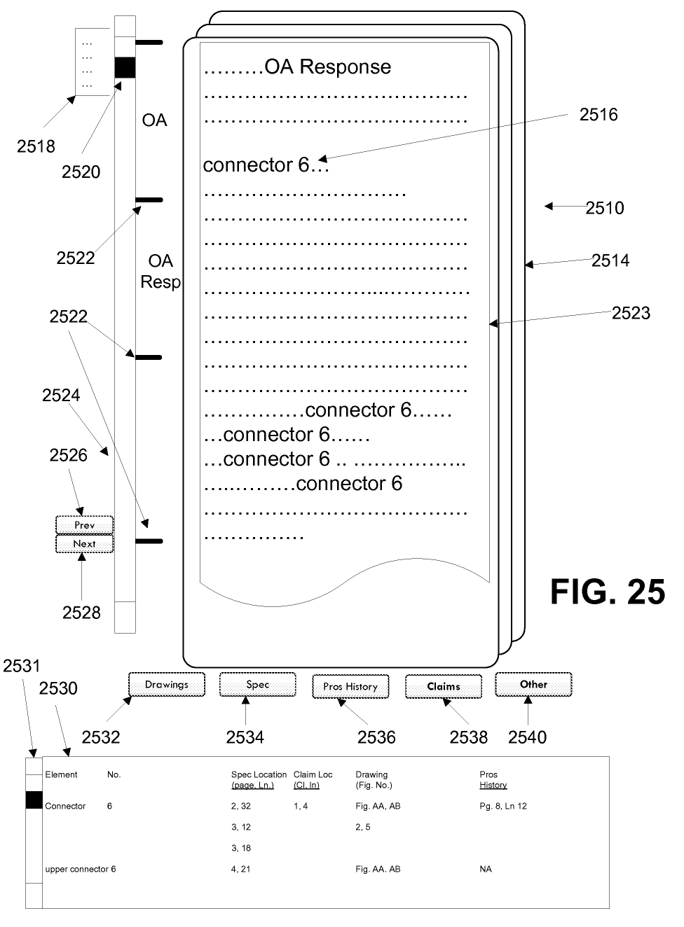

Referring now to FIG. 23, another example showing a format for the output of linked common identifiers generated in step 2574 is shown and described. In FIG. 23, a display 10 is shown having the specification page 2512 at a front or displayed location and back pages 2514 not displayed. In the example of FIG. 23, each of the pages provides a view of a different document. In the example shown in FIG. 23, specification page 2512 displays the specification of a patent at a front or displayed location and highlights the common identifier (specification element) “connector 6.” In the example, back pages 2514 include, drawings, prosecution history, claims, and other documents. As shown in FIGS. 24 and 25, drawings page 2521 and prosecution history page 2523 may be moved to a displayed or front page position by selection of drawing button 2532 or prosecution history button 2536 respectively. Likewise, one will readily understand that selecting claims but in 2538 or other button 2540 will provide likewise displays of a claim section or another document (as will be described) to the front-page display.

At the lower portion of FIG. 23, a linking display 2530 is provided. Like that described for FIG. 10, linking display 2530 provides an index of common identifiers, in this case specification elements or claim elements, as well as additional information (as discussed with respect to FIG. 10) regarding such common identifiers. In the example, selection of a common identifier in the linking display causes that common identifier in the front-page portion (whether the drawings, specification, prosecution history, claims or other is currently in the front page position) to be identified such as, but not limited to, highlighting or bolding. As shown in FIG. 23, the common identifier connector 6 is in bold when connector 6 in the linking display 2530 is selected. Likewise, in FIG. 25, the element number “6” and the drawings is bolded and also labeled with the term “connector” when that common identifier is selected in the linking display 2530. Similar identification may be used for prosecution history, claims or alternate source. It will be understood that the present invention contemplates any means or form of identification beyond highlighting or bolding, and may include any known means or feature of identification.

Scrollbar 2524 is shown at a left side region of FIGS. 23, 24 and 25. In one example, the length of the scrollbar represents the entire length of the document in the display 2510. The scrollbar 2524 includes a display region 2518 that illustrates what portion of the entire document is currently being displayed in the front page of view. More specifically, the upper and lower brackets of the display region 2518 represent the upper and lower borders of the specification page 2512 in FIG. 23. One will readily understand that when the scrollbar is scrolled down, the display at the front-page view will move up exposing lower features and hiding upper displayed features of the document and will cause the display region 2518 to move down along the scrollbar 2524.

The scrollbar 2524 also includes a hit map representing the location of common identifiers in the document at the front page position in the display 2510. In the example of FIG. 23, location 2520 represented by a dark block represents a high concentration of common identifiers (in the example, connector 6 at 2516) located on the portion of the specification that is currently being displayed. When one looks at the display to the right, one sees a high concentration of the term “connector 6.”

Section breaks 2522 are provided to divide a document into sub regions. For example, in FIG. 23, the section breaks break the specification into a specification section and a claim section. In FIG. 24, section breaks 2522 break the drawings into different figures. In FIG. 25, section breaks 2522 break the prosecution history into different features such as office action, office action response, restriction requirements or other known distinctions. Identification of each of these regions or breaks may be performed as described with respect to FIGS. 1-5 in the present application. As stated previously, a document may represent an entire piece of information such as the entirety of a written patent or may represent individual components of a patent such as a specification section or claim section. In the example presently described, a document in FIG. 23 includes both the specification section and claim section. By this way, one can tell from the scrollbar, hit map and section breaks as to what part of a document they are currently viewing and where the common identifiers are located in such document.

Previous button 2526 and next button 2528 allows the user to jump to the most previous and next common identifier in the document. For example, selecting next button 2528 causes the scrollbar to move down and display the next common identifier such as “connector 6” that is not currently being displayed in the front-page view.

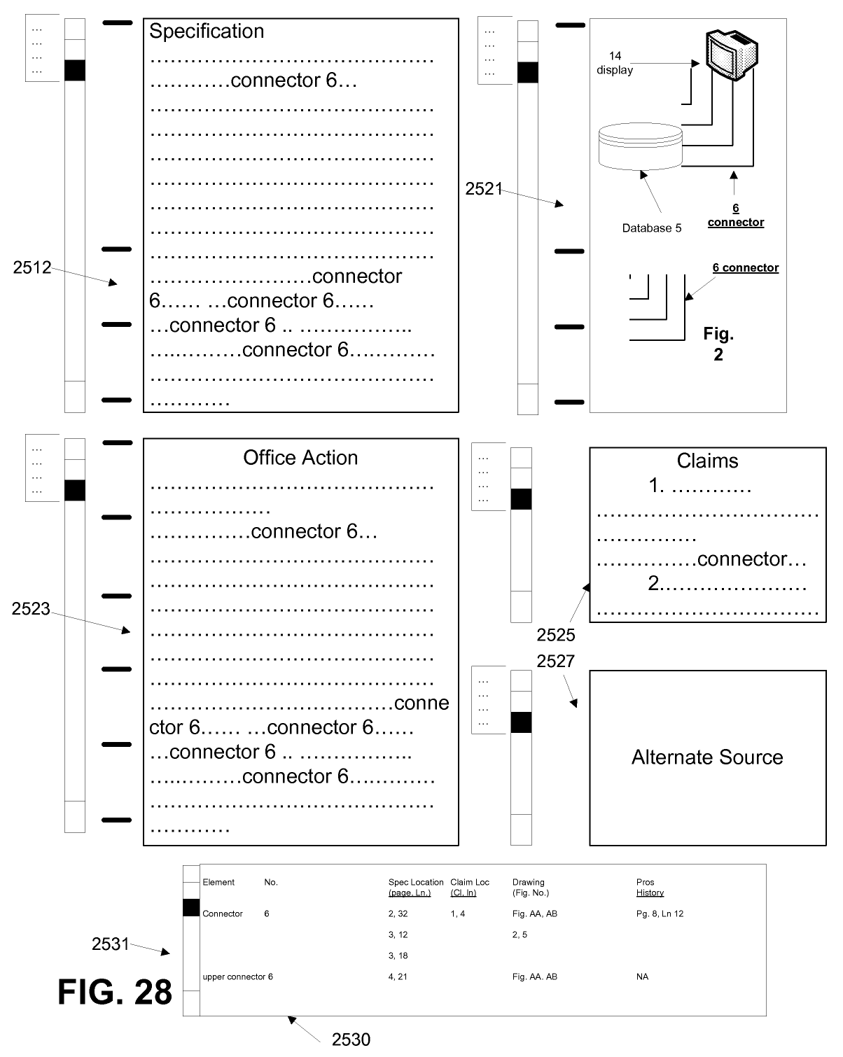

Referring now to FIG. 28, another example is shown and described. In FIG. 28, multiple document displays are shown in a single display. More specifically, the specification page 2512 is positioned at an upper left location with its associated scrollbar and breaks, prosecution history 2523 is shown at a lower left portion with its associated features, drawing page 2521 is shown at an upper right position with its associated features, claims page 2525 shown at a middle right position, and alternate source page 2527 is shown at a lower right position. It will be understood that the alternate source page 2527 may be displayed by selecting the other button 2540 in any of the described examples.

Referring now to FIG. 27, an example for the alternate source 2527 is shown and described. In FIG. 27, a tree diagram is provided that shows branches of prosecution for an example patent. In the example illustrated, a priority patent is filed at block 2564. The patent currently being analyzed (such as in specification page 2512, drawing page 2521, or prosecution history page 2523) is represented at block 2562. An associated foreign patent application based on the priority application referenced at block 2564 is shown at block 2560. Likewise, a continuation application is shown at block 2556 and a divisional application is shown at lock 2558. It will also be understood that the alternate source 2527 may include additional features of any one of these applications such as the prosecution history.

In the example of FIG. 27, selection of any one of the blocks illustrated therein positions that corresponding document into the alternate source 2527. The alternate source positioned in the display, as will be understood, is processed in accordance with the processing of documents as described in FIG. 30. By this way, the user may view additional documents related to the displayed document.

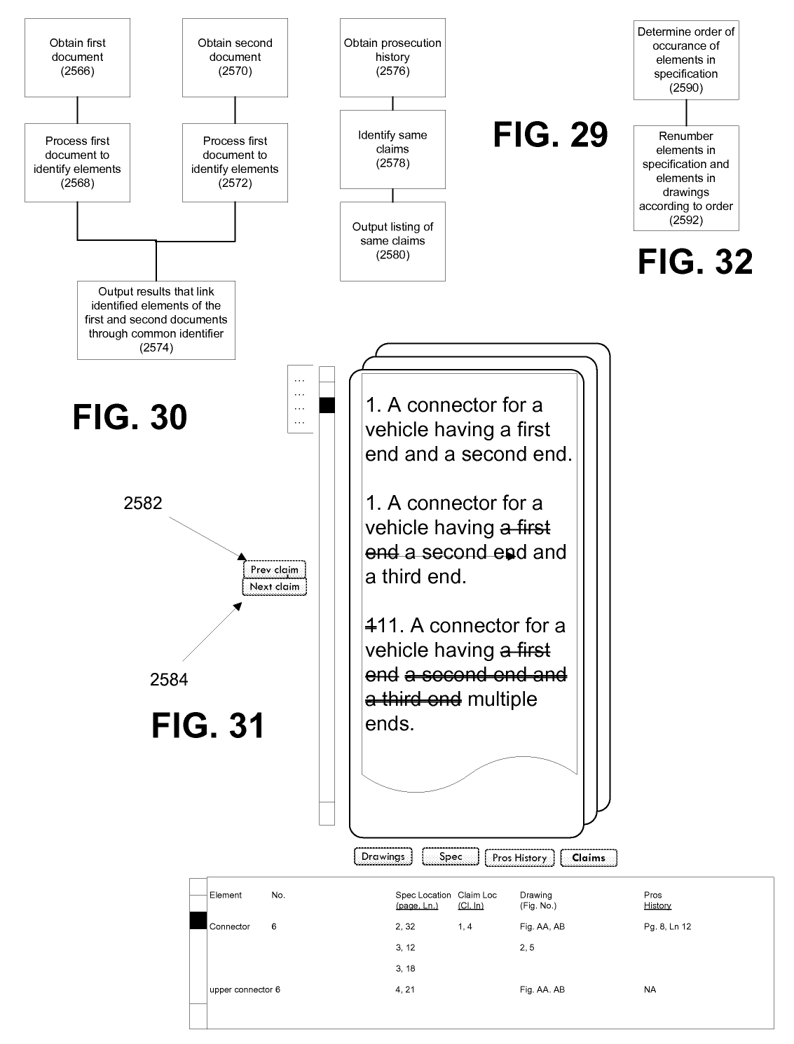

Referring now to FIG. 29, another example is shown in described. In FIG. 29, claim amendments conducted during prosecution are identified to determine changes in alterations thereto. In one example, an analysis in accordance with FIG. 22 is performed throughout the prosecution history of a patent to identify the same claims. In step 2576, such prosecution history is obtained. In step 2578, the claims throughout the prosecution history are analyzed to determine which of the claims are the same. For example, where each claim includes the claim number 1 am very similar claim language, such claims will be deemed to be the same. The claims are then analyzed to determine similarities and differences from the beginning of the prosecution to the end of the prosecution. Such analysis may be accomplished by known word and language comparisons. In step 2580, the claims as amended is output in a display format. Referring to FIG. 31, the claims are listed in order from start of prosecution to end of prosecution from the top of the displayed document to the bottom. As can be seen, when a claim is change or altered, such change or alteration is displayed in the view.

Referring now to FIG. 32, another example is shown in described. In the example of FIG. 32, the first document is a textual document of a patent, such as the specification, and a second document is a graphical document of a patent such as the drawings. During patent drafting, it sometimes occurs that patent drafters do not number or label drawings in order and have to come at some later time to renumber the element numbers in the patent drawings in renumber specification elements in the specification. In FIG. 32, the output from step 2574 in FIG. 30 is fed into step 2590. In step 2590, the order of occurrence of each of the word portion of the specification elements is determined. For example, if the specification element “connector 6” occurs first in the specification and the specification element “hitch 2” occurs next in the specification, then the term connector 6 will be deemed first in order and the term “hitch 2” will be deemed second in order. Again, such ordering may be determined through the process is described in the present application including but not limited to those described with respect to FIGS. 1-5. In step 2592, the specification elements in the text document and the element numbers in a drawing document are then relabeled in accordance with their order in the specification. In the example described above, “connector 6” would be relabeled “connector 2” and the term “hitch 2” would be relabeled “hitch 4.” Such labeling may be performed through process as described in this application as well as common find/paste operations in word processing applications. In the drawings, the element number “6” would be relabeled as “2.” Likewise, the element number “2” in the drawings would be relabeled as “4.” Again, such may be performed through process is described in the present application.

As discussed herein, the identification of text associated with documents, documents sections, and graphical images/figures, may be provided by analysis of the text or images themselves and/or may also be provided by data associated with the document, or graphical images/figures. For example, an image file may contain information related to it, such as a thumbnail description, date, notes, or other text that may contain information. Alternatively, a document such as a XML document or HTML document may contain additional information in linking, descriptors, comments, or other information. Alternatively, a document such as a PDF file may contain text overlays for graphical sections, the location of the text overlay, or metadata such as an index or tabs, may additionally provide information. Such information, from various sources, and the information source itself, may provide information that may be analyzed in the document's context.

Document. A document is generally a representation of an instrument used to communication an idea or information. The document may be a web page, an image, a combination of text and graphics, audio, video, and/or a combination thereof. Where OCR is discussed herein, it is understood that video may also be scanned for textual information as well as audio for sound information that may relate to words or text.

Document Content Classification. Documents groups may be classified and related to a collection of documents by their content. An example of document groups in the context of patent documents may include a class, a subclass, patents, or published applications. Other classes of documents may include business documents such as human resources, policy manuals, purchasing documents, accounting documents, or payroll.

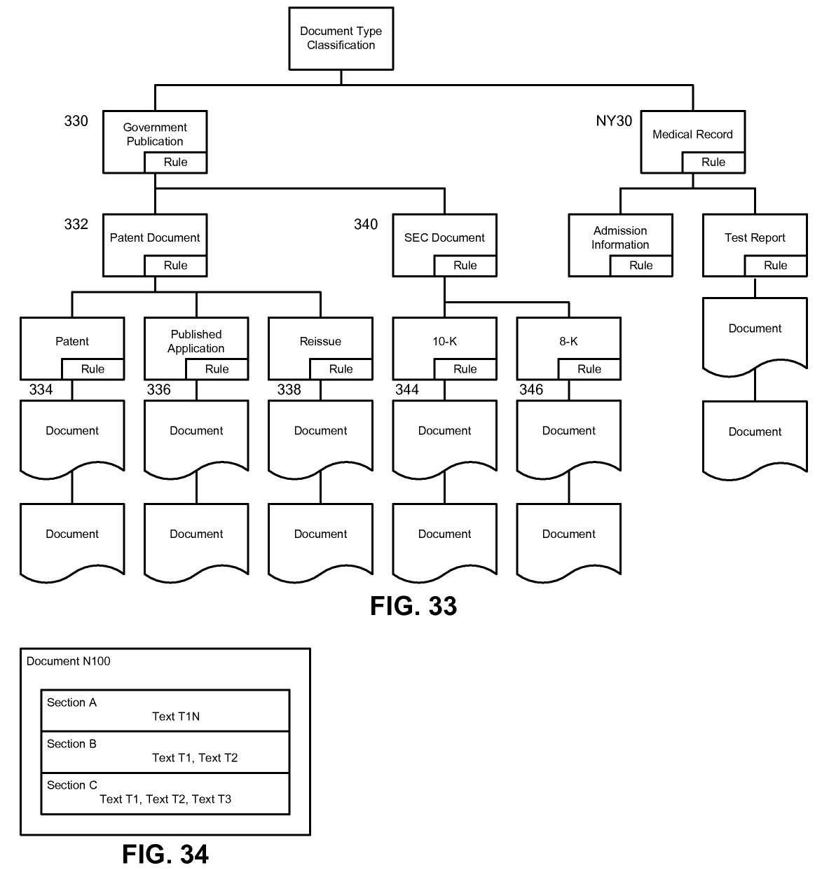

Document Type Classification. Documents may be classified into document types by the nature of the document, the intended recipient of the document, and/or the document format. Document types may include a patent document, a SEC filing, a legal opinion, etc. The documents may be related to a common theme to determine the document type. For example, FIG. 33 is a document Type classification tree that includes a document type for government publications (330) and medical records (NY30). Government publications (330) may be further sub-classified as a patent document (332) or a SEC document (340). They may further be subdivided by type (e.g., a patent document (334), a published application (336), a reissue patent (338), an SEC 10-K (344), and an SEC 8-K (346)). Moreover, each classification may include a rule to be associated with preprocessing to generate metadata (see below), indexing, or searching. The rules provide structure for determining where information should be subdivided into sections, whether linking of information is appropriate, and/or how to assign relevancy to the information, linking, and document sections based on the desired search type (e.g., a novelty search vs. an infringement search). The rules may be generated automatically by analyzing the document structure, or by user input. For example, the patent document (332) may have user defined rules such as sectionalizing the document by drawings, detailed description, and claims, having elements extracted therefrom, and element linking added to the document. Each document type classification may have its own rules, as well as more particularized rules for each sub-classification.

Document Section. FIG. 34 is an example of a document having sections. Documents may be examined to divide the document into document sections. Each document may then be analyzed, indexed and/or searched according to its content, the indexing and searching being customized based on the document type. Information types may broadly include many representations of information for the document, some which may be visible to the user, some that may be embedded. Examples of information types may include text, graphics, mixed graphics and text, metadata, charts (e.g., pie and bar), flowcharts tables, timelines, organizational diagrams, etc. The document sections may be determined by a rule, for example, the rules associated with certain document type classifications (e.g., see FIG. 33). For example, FIG. 34 shows Section A, Section B, and Section C. Where Document N100 is a patent document (e.g., 334 of FIG. 33), Section A includes drawing pages and drawing figures, Section B includes the detailed description, and Section C includes the claims.

Document sections may have different meaning based on the document type. For example, a patent document (e.g., a patent or a patent application) may include a “background section” a “detailed description section” and a “claims section”, among others. An SEC filing 10-K document may include an “index”, a “part” (e.g., Part I, Part II), and Items. Further, these document sections may be further assigned sub-sections. For example, the “claims” section of a patent may be assigned sub-sections based on the independent claims. For an SEC document, the sub-sections may include financial data (including tables) and risk section(s). Sections may also be determined that contain certain information that may be relevant to specialized searches. Examples may include terms being sectionalized into a risk area, a write down area, an acquisition area, a divestment area, and forward looking statements area. Legal documents may be sectionalized into a facts section, each issue may be sectionalized, and the holding may be sectionalized. In the search or indexing (as described herein), the proximity of search terms within each section may be used to determine the relevancy of the document. In an example, where only the facts section includes the search terms, the document may be less relevant. In another example, where the search terms appear together in a specific section (e.g., the discussion of one of the issues) the document may become more. In another example, where search terms are broken across different sections, the document may become less relevant. In this way, a document may be analyzed for relevancy based on document sections, where existing keyword searches may look to the text of the document as a whole, they may not analyze whether the keywords are used together in the appropriate sections to determine higher or lower document relevancy.

Text. Text may be comprised of letter, numbers, symbols, and control characters that are represented in a computer readable format. These may be represented as ASCII, ISO, Unicode, or other encoding, and may be presented within a document as readable text or as metadata.

Image. An image may be comprised of graphics, graphical text, layout, and metadata. Graphics may include a photograph, a drawing (e.g., a technical drawing), a map, or other graphical source. Graphical text may include text, but as a graphical format, rather than computer readable text as described above.

Audio. Audio information may be the document itself or it may be embedded in the document. Using voice recognition technology, a transcript of the audio may be generated and the methods discussed herein may be applied to analyze the audio.

Video. A video may be included in the document, or the document itself. As discussed herein, the various frames of the video may be analyzed similarly to an image. Alternatively, a sampling of frames (e.g., one frame per second) may be used to analyze the video without having to analyze every frame.

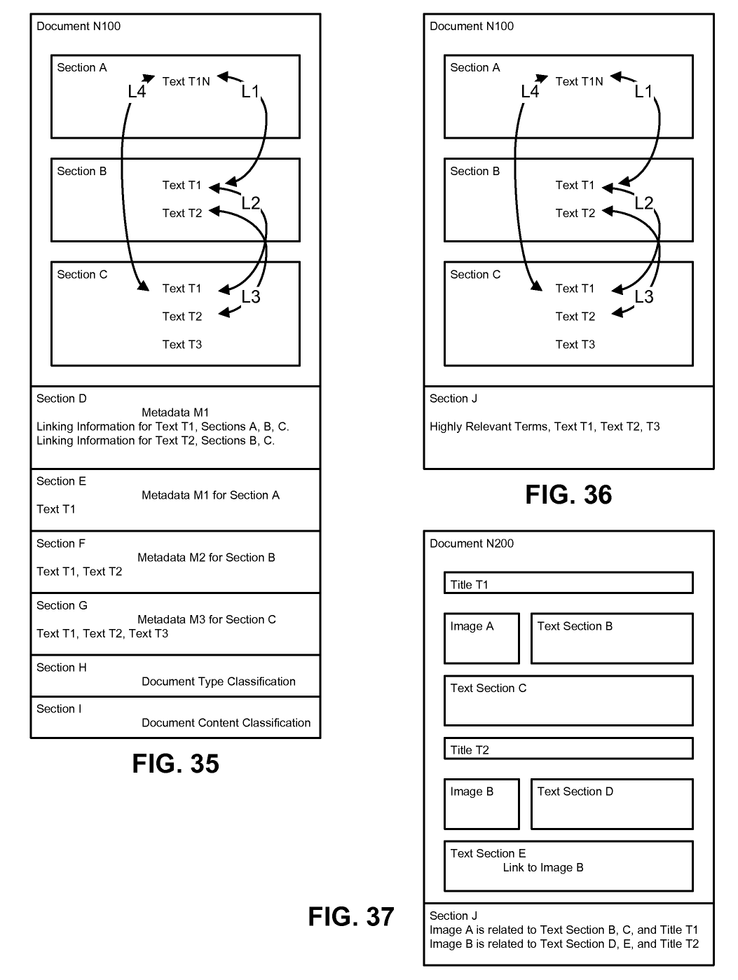

Document Analysis. FIG. 35 is an example of document analysis for improved indexing, searching, and display. A document N100 includes, for example, three sections, Section A, Section B, and Section C. The document sections (A, B, C) may be determined from the Document Type Classification. In a patent document, Section A may include drawing images (and may further include subsections for each drawing page and drawing figure), Section B may include the detailed description (and may further include subsections for drawing figure references, paragraphs, tables, etc.), and Section C may include the claims (and may further include subsections for each independent claim, and dependent claims).

An information linking method may be performed on the Document N100 to provide links between text in each section (e.g., Sections A, B, C), see FIG. 35 for a detailed description on information linking within a document. Such linking information may be included in a generated metadata section, Section D, that contains linking information for the text within each of Sections A, B, C. In general, keywords or general text may be associated with each other between sections. In an example, Text T1 appearing in the claims Section C as a “transmission” may be associated by link L2 to an appearance of “transmission” in the detailed description Section B. In another Example, the Text T1 appearing in the detailed description Section B as “transmission 10” may be linked L1 with a drawing figure in Section A where element number “10” appears. In another example, the Text T1 appearing in the claims Section C as “transmission” may be linked L4 with a drawing figure in Section A by the appearance of element number “10”, the relation of element name “transmission” and element number “10” provided by the detailed description. In another example, Text T2 appearing in the claims Section C as a “bearing” may be associated by link L3 to an appearance of “bearing” in the detailed description Section B.

Another generated metadata section, Section E, may include additional information on Section A. For example, where Section A is a graphical object or set of objects, such as drawing figures, Section E may include keyword text that relates to section A. In an example where Section A is a drawing figure that includes the element number “10” as Text TIN, relational information from the detailed description Section B, may be used to relate the element name “transmission” (defined in the detailed description as “transmission 10”) with element number “10” in Section A. Thus, an example of metadata generated from the Document N100 may include Section E including the words “transmission” and/or “10”. Further, the metadata may be tagged to show that the element number is “10” and the associated element name is “transmission”. Alternatively, Section E could include straight text, such as “transmission”, “transmission 10”, and/or “10”, to be indexed or further used in searching methods. Such metadata may be used in the search or index field to allow for identification of the drawing figure when a search term is input. For example, if the search term is “transmission”, Section E may be used to determine that “FIG. 1” or “FIG. 2”, of Document N100, is relevant to the search (e.g., for weighting using document sections to enhance relevancy ranking of the results) or display (e.g., showing the user the most relevant drawing in a results output).

Another generated metadata section, Section F, may include metadata for Section B. In an example, Section B may be assigned to the detailed description section of a patent document. Section F may include element names and element numbers, and their mapping. For example, Text T1 may be included as “transmission 10” and text T2 may include “bearing 20”. Moreover, the mapping may be included that maps “transmission” to “10” and “bearing” to “20”. Such mapping allows for the linking methods (e.g., as described above with respect to Text T1 in section B “transmission” with Text TIN “10” in section A). Section F may be utilized in a search method to provide enhanced relevancy, enhanced results display, and enhanced document display. For example, in determining relevancy, when a search term is “transmission”, Section F allows the search method to boost the relevancy for the term with respect to Document N100 for that term because the term is used as an element name in the document. This fact that the search term is an element may indicate enhanced relevancy because it is discussed in particularity for that particular document. Additionally, the information may be used enhance the results display because the mapping to a drawing figure allows for the most relevant drawing figure to be displayed in the result. An enhanced document display (e.g., when drilling down into the document from a results display) allows for linking of the search term with the document sections. This allows for the display to adapt to the user request, for example clicking on the term in the document display may show the user the relevant drawing or claim (e.g., from Sections A, C).

Another generated metadata section, Section G, may include metadata for the claims section of Document N100. Each claim term may be included for more particularized searching and with linking information to the figures in Section A. For example, where claim 1 includes the word “transmission”, it may be included in Section G as a claim term, and further linked to the specification sections in Section B that use the term, as well as the figures in Section A that relate to “transmission” (linking provided by the detailed description or by element numbers inserted into the claims).

Another generated metadata section, Section H, may include Document Type Classification information for Document N100. In this example, the Document Type may be determined to be a patent document. This may be embodied as a code to straight text to indicate the document type.

Another generated metadata section, Section I, may include Document Content Classification information for Document N100. In this example, the document class may be determined as being the “transmission” arts, and may be assigned a class/subclass (as determined b the United States Patent and Trademark Office). Moreover, each section of Document N100 may be classified as to content. For example, Section C includes patent claims that may be classified. In another example, the detailed description Section B may be classified. In another example, each drawing page and/or drawing figure may be classified in Section A. Such classification may be considered document sub-classification, which allows for more particularized indexing and searching.

It is also contemplated that the metadata may be stored as a file separate from Document N100, added to Document N100, or maintained in a disparate manner or in a database that relates the information to Document N100. Moreover, each section may include subsections. For example, Section A may include subsections for each drawing page or drawing figure, each having metadata section(s). In another example, Section C may include subsections, each subsection having metadata sections, for example, linking dependent claims to independent claims, claim terms or words with each claim, and each claim term to the figures and detailed description sections. Classification by document section and subsection allows for increased search relevancy.

When using the metadata for Document N100, an indexing method or search method may provide for enhanced relevancy determination. For example, where each drawing figure is classified (e.g., by using element names gleaned from the specification by element number) a search may allow for a single-figure relevancy determination rather than entire document relevancy determination. Using a search method providing for particularized searching, the relevancy of a document including all of the search terms in a single drawing may be more relevant than a document containing all of the search terms sporadically placed throughout the document (e.g., one search term in the background, one search term in the detailed description, and one search term in the claims).

In another example, FIG. 36 shows an analysis of Document N100 to determine the highly relevant text that may be used in indexing and searching. Metadata Section J may include, after document analysis, terms from Document N100 that are deemed highly relevant by the Document Type Rule. For example, in a patent document, Section J includes terms that are used elements in the drawings (e.g., from Section A), elements used in the specification (e.g., numbered elements or noun phrases), and elements used in the claims Section C. In this way, data storage for the index is reduced and simplified search methods may be employed. In another example, only linked terms may be included, for example terms that are linked through Links L1, L2, L3, L4 are included in Section J as being more relevant than the general document text.

Depending on the universe of documents to be searched, the analysis of the document may be performed at index time (e.g. prior to search) or at the search time (e.g., real-time or near real-time, based on the initially relevant documents).

In another example, FIG. 37 includes a general web page that may be sectionalized and analyzed by a general web page rule. The title for a section of the page may be determined as Title T1, and the next title T2 is identified. The image(s) and text between Title A and Title B may be assigned to a document section under Title A. The image(s) and text between below Title B may be assigned to a document section under Title B. Moreover, the text of the section may be identified as being associated to an image. In this example, Text Sections B and C are associated with Image A, and Text Sections D and E are associated with Image B. Metadata may then be associated with Document N200 to allow for indexing and searching of the image based on the associated text. Additional analysis may be provided by a Link to Image B (in Text Section E) that further provides information about Image B. For example, the text in the same sentence or surrounding Link to Image B may be further particularized as relevant to Image B, including the shown text of the link or metadata associated with the link in the source (e.g., in HTML or XML source).

When analyzing a web page, the sectionalization may include sectioning the web-site's index or links to other pages, as well as sectioning advertisement space. The “main frame” may be used as a section, and may be further sub-sectioned for analysis. By providing that the web-site's index or links are sectioned separately, a search for terms will have higher relevancy based on their presence in the main frame, rather than having search terms appearing in the index. Moreover, the advertisement area may not be indexed or searched because any keywords may be unrelated to the page.

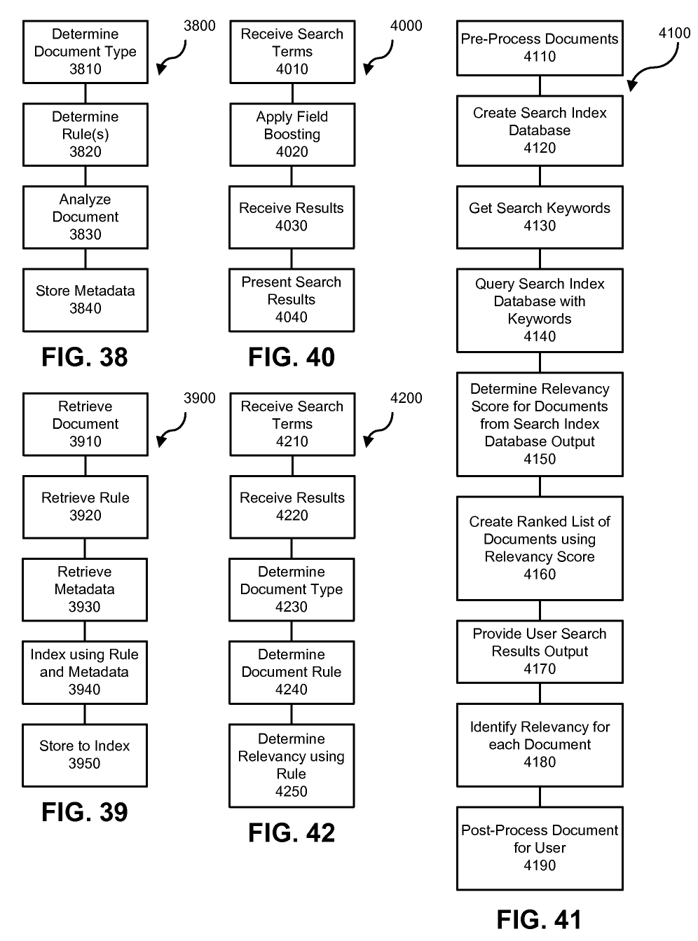

FIG. 38 is an example of a document analysis method. In general, a document may be analyzed by determining the document type, retrieving a rule to analyze the document, and storing information about the document to assist in indexing and/or searching.

In step 3810, the document may be retrieved and the document type ascertained. The document type may be determined from the document itself (e.g., by analyzing the document) or by metadata associated with the document. The document itself need not be retrieved to determine the document's type if there is data available describing the document, such as information stored on a server or database related to the document.

In step 3820, the rule may be determined for the document under analysis. The determination may be performed automatically or manually. Automatic rule determination may be done using a document classifier that outputs the document type. The rule can then be looked up from a data store. An example of a rule for a patent document includes determining the document sections (bibliographic data, background, brief description of drawings, detailed description, claims, and drawings). Such a rule may look for certain text phrases that indicate where the sections begin, or determining from a data source, where the sections are located. Analysis of the drawing pages and figures is requested, determination of the specification elements and claim elements, and linking information is requested between sections. An example of a rule for an SEC document includes determining what type of SEC document it is, for example a 10-K or an 8-K. In an example, a 10-K may be analyzed. The rule may provide for identification of a table of contents, certain parts, and certain items, each of which may be used for analysis. Further, there may be rules for analyzing revenue, costs, assets, liabilities, and equity. Rules may also provide for analyzing tables of financial information (such as relating numbers with columns and rows) and how to indicate what the data means. For example, a number in a financial table surrounded by parentheses “( )” indicates a loss or negative numerical value. An example of a rule for a book includes determining the book chapters.

In step 3830, the document is analyzed using the rules. For example, the document is sectionalized based on the rule information. A patent document may be sectionalized by background, summary, brief description of drawings, detailed description, claims, abstract, and images/figures.

In step 3840, metadata related to the document may be stored. The metadata may be stored with the document or may be stored separate from the document. The metadata includes, at least in part, information determined from the rule based analysis of step 3830. The metadata may further be stored in document sections provided for by the rule applying to the document. In an example, a patent document may include a document section that includes the element names from the detailed description. Each of the element names determined from the document analysis in 3830 may be stored in the section specified by the rule. Such a new section allows the indexer and/or searcher to apply weighting factors to the section's words that may assist in providing more relevant documents in a search.

FIG. 39 is an example of a document indexing method. In step 3910, the document may be retrieved and the document type ascertained. The document type may be determined from the document itself (e.g., by analyzing the document) or by metadata associated with the document. The document itself need not be retrieved to determine the document's type if there is data available describing the document, such as information stored on a server or database related to the document.

In step 3920, the rule may be determined and the rule retrieved for the document under analysis. The determination may be performed automatically or manually. Automatic rule determination may be done using a document classifier that outputs the document type. The rule can then be looked up from a data store. An example of a rule for a patent document includes determining the document sections (bibliographic data, background, brief description of drawings, detailed description, claims, and drawings). Such a rule may look for certain text phrases that indicate where the sections begin, or determining from a data source, where the sections are located. Analysis of the drawing pages and figures is requested, determination of the specification elements and claim elements, and linking information is requested between sections. An example of a rule for an SEC document includes determining what type of SEC document it is, for example a 10-K or an 8-K. In an example, a 10-K may be analyzed. The rule may provide for identification of a table of contents, certain parts, and certain items, each of which may be used for analysis. Further, there may be rules for analyzing revenue, costs, assets, liabilities, and equity. Rules may also provide for analyzing tables of financial information (such as relating numbers with columns and rows) and how to indicate what the data means. For example, a number in a financial table surrounded by parentheses “( )” indicates a loss or negative numerical value. An example of a rule for a book includes determining the book chapters.

In step 3930, the document's metadata may be retrieved. The metadata may be in the document itself or it may be contained, for example, on a server or database. The metadata may include information about the document, including the document's sections, special characteristics, etc. that may be used in indexing and/or searching. For example, a patent document's metadata may describe the sectionalization of the document (e.g., background, summary, brief description of drawings, detailed description, claims, abstract, and images/figures). The metadata may also include, for example, the information about generated sections, for example that include the numbered elements from the specification and/or drawing figures.

In step 3940, the document and metadata may be indexed (e.g., for later use with a search method). The flat document text may be indexed. In another example, the metadata may be indexed. In another example, the sectional information may be indexed, and the text and/or images located therein, to provide for enhanced relevancy determinations. For example, the specification sections may be indexed separately to fields so that field boosting may be applied for a tuned search. Moreover, the information about the numbered elements from the specification, drawings, and/or claims may be indexed in particular fields/sections so that boosting may be applied for enhanced relevancy determinations in a search.

In step 3950, the information is stored to an index for later use with a search method.

FIG. 40 is an example of a document search method 4000.

In step 4010, search terms are received. The search terms may be input by a user or generated by a system. Moreover, as discussed herein, the search may be tuned for a particular purpose (e.g., a novelty search or an infringement search).

In step 4020, field boosting may be applied for searching (see also FIG. 43). The field boosting may be applied to document sections to provide enhanced relevancy feedback of the documents searched.

In step 4030, results are received for the search. The results may be ranked by relevancy prior presentation to a user or to another system. In another example, the results may be processed after the search to further determine relevancy. Document types may be determined and rules applied to determine relevancy.

In step 4040, results are presented to the user or another system.

FIG. 41 is a method 4100 for indexing, searching, presenting results, and post processing documents in a search and review system (e.g., such as a search engine allowing the user to peruse the results to determine which result is interesting).

In step 4110, documents are pre-processed. A determination as to the document type and the rule to be applied to the pre-processing may be determined. The rules may then be applied to the document to provide sectionalization, generation of metadata, and addition of specialized sections/fields for indexing and/or searching.

In step 4120, the document may be indexed. The document sections may be indexed, as well as the metadata determined in pre-processing methods.

In step 4130, search terms may be received.

In step 4140, the index of step 4120 may be queried using the search terms and search results may be output.

In step 4150, the relevancy score for the search results may be determined. The relevancy may be determined based on field boosting, or analysis of the result document, based on rules. For example, the search terms found in drawings, or different sections may be used to increase or decrease relevancy.

In step 4160, the results may be ranked by relevancy.

In step 4170, the results may be presented to the user based on the ranked list of step 4160.

In step 4180, the relevant portions of the documents may be presented to the user. For example, the relevant portions may include the most relevant image/drawing, or the most relevant claim, based on the search terms.

In step 4190, the document may be post processed to provide the user with an enhanced document for further review. The enhanced document may include, for example, highlighting of the search terms in the document, and linking of terms with figures and/or claims. In another example, the linking of different sections of the document may provide the enhanced document with interactive navigation methods. These methods may provide for clicking on a claim term to take the document focus to the most relevant drawing with respect to a claim. In another example, the user may click on a claim term in the specification to take the document focus to the most relevant claim with respect to that term or the most relevant drawing.

FIG. 42 is a method 4200 of searching a document based on document type.

In step 4210, search terms are received. The search terms may be provided by a user or other process (e.g., as discussed herein a portion of a document may be used to provide search terms).

In step 4220, a search may be run and results received. The search may be performed and a plurality of document types may be received as results. For example, patent documents, web pages, or other documents may be received as results.

In step 4230, the type of document in the results may be determined (see FIG. 33). The type of document may be included as metadata to the document or the document type may be determined by a document type analyzer (e.g., for a patent document, the presence of certain document sections (e.g., claims, detailed description, background, and drawings) indicates that it is a patent document).

In step 4240, the appropriate document rule is retrieved for each document (see FIG. 33). The document rules may be saves with the document itself, or the document rule may be retrieved, for example, from a database or server.

In step 4250, the relevancy of the results documents are determined using the rule appropriate for each document type. For example, patent document relevancy may be determined using the patent document rule, SEC documents may have SEC document rules applied, and general web pages may have general web page rules applied. For example, a patent document rule may include determining relevancy based on the presence of the search terms in a figure, the claims, being used as elements in the detailed description, etc.

Search. In general, document searching provides for a user input (e.g., keywords) that is used to determine relevancy for a set of documents. The documents are then provided as a ranked list of document references. In determining relevancy, many document properties may be analyzed to determine relevancy. In an example, keywords are provided as a user input to a set of documents for search. Relevancy score may then be determined based on the presence of the keyword, or analogous words.

Relevancy Score. Relevancy may be determined by a number of factors that include the keywords, keyword synonyms, context based synonyms, location of keywords in a document, frequency of keywords, and their location relative to each other.

In an example, a keyword search is performed on a set of documents that include, for example, patents and published patent applications. The relevancy of each document in the set may be determined by a combination of factors related to the location(s) of the keywords within each document, and the relative location of the keywords to each other within the document.

In general, the methods described herein may be used with an indexing and search system. A crawler may be used to navigate a network, internet, local or distributed file repository to locate and index files. A document classifier may be used prior to indexing or after searching to provide document structure information in an attempt to improve the relevancy of the search results. The document classifier may classify each document individually or groups of documents if their general nature is known (e.g., documents from the patent office may be deemed patent documents or documents from the SEC EDGAR repository may be deemed SEC documents). The determination of rules for analysis of the documents may be applied at any stage in the document indexing or searching process. The rules may be embedded within the document or stored elsewhere, e.g. in a database. The documents may be analyzed and indexed or searched using the rules provided. The rules may also provide information to analyze the document to create metadata or a meta-document that includes new information about the document including, but not limited to, sectionalization information, relationships of terms within the document and document sections, etc. An index may use the results of the analysis or the metadata to identify interesting portions of the document for later search. Alternatively, the search method may use metadata that is stored or may provide for real-time or near real-time analysis of the document to improve relevancy of the results.

FIGS. 43-45 are examples of determining relevancy for patent documents using term searching. FIG. 43 shows the fields used for search, where each field may be searched and weighted individually to determine relevancy. In general, the patent document may be portioned into different fields (e.g., see the determination and definition of sections for documents explained in detail above with respect to FIG. 35, among others). The fields may then be used to apply various weighting that will determine relevancy.

FIG. 44 is a relevancy ranking method where each field may have boosting applied to make the field more relevant than others. When performing a patent “novelty” search, the detailed description section and drawings sections have higher relevancy than, for example, the background section. It will be understood, however, that the example provided herein is not limited to such relevancy and this is merely one example. Thus, by applying field boosting to the detailed description section and the drawings section, the relevancy determination is aligned to the type of search. The lowest relevancy may be a search term hit in the background section. Alternatively, the highest relevancy may be a term hit in the detailed description and drawings section. Moreover, where the term hits are in the same figure, the inference is that they are described within the same apparatus feature rather than in different regions of the document, making the hit more relevant. In kind, where the term hits are in the same paragraph of the detailed description, the general inference is that they are described within the same specific discussion, rather than being described in disparate sections of the document. As shown, a number of other fields are shown as being ranked as more or less relevant. The example shown in FIG. 44 is an example of field boosting for a novelty search, and the user may desire to modify the field boosting for tuning relevancy to their particular application.

FIG. 45 is a relevancy ranking method for a patent “infringement” search. In this example, the claims section has a higher relevancy than the background. As an example, the highest relevancy is applied to search term hits that are in the claims section, and the detailed description section, and the drawings section.

FIG. 46 is a general relevancy ranking method for patent documents. As shown the least relevancy is provided by term hits in the background section of the document. The highest relevancy is provided by all of the search terms used in the same drawing figure. In an example, the user may search for terms X, Y, Z in patent documents. Relevancy may be based on keywords being in the same figures and in the same text discussion (e.g., same section, same paragraph). An example of a ranking of search results is provided. Rank 0 (best) may be when X, Y, Z are used in the same figure of a document. Rank 1 may be when X, Y, are used in same figure of a document, and Z is used in different figures of the document. Rank 2 may be when X, Y, Z are used in different figures of the document. Rank 3 may be when X, Y, Z are found in the text detailed description (but not used as elements in the figures). Rank 4 may be when X, Y, Z are found in the general text (e.g., anywhere in the text) of the document, but not used as elements in the figures. Rank 5 (worst) may be when X, Y are discussed in the text, and Z is found in the background section (but not used as elements in the figures). In this way, a generalized search of patent documents can be performed with high accuracy on the relevancy of the documents.

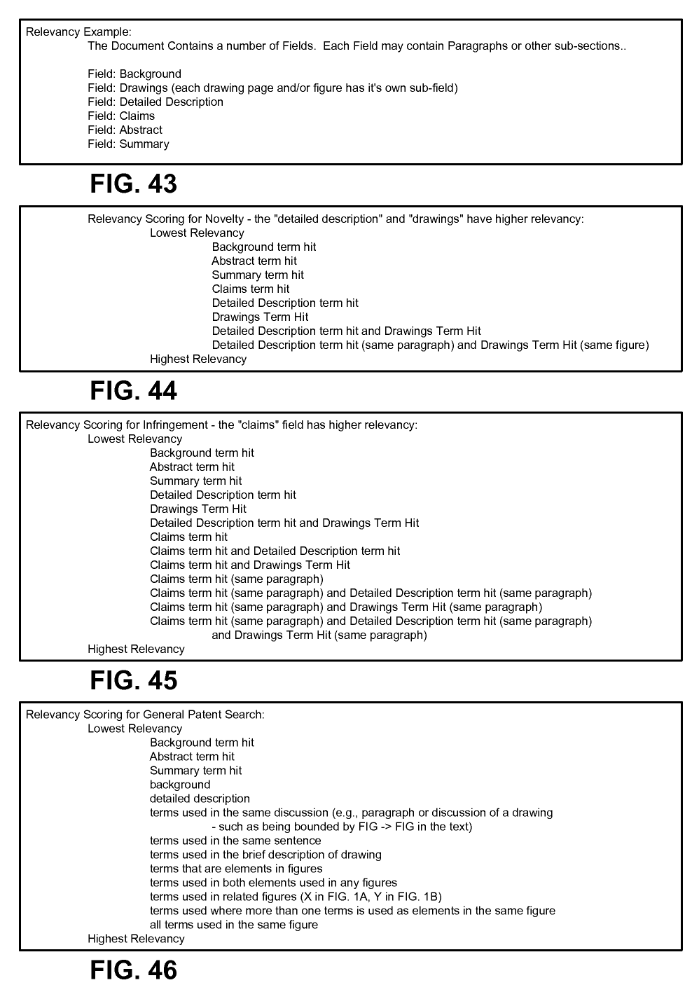

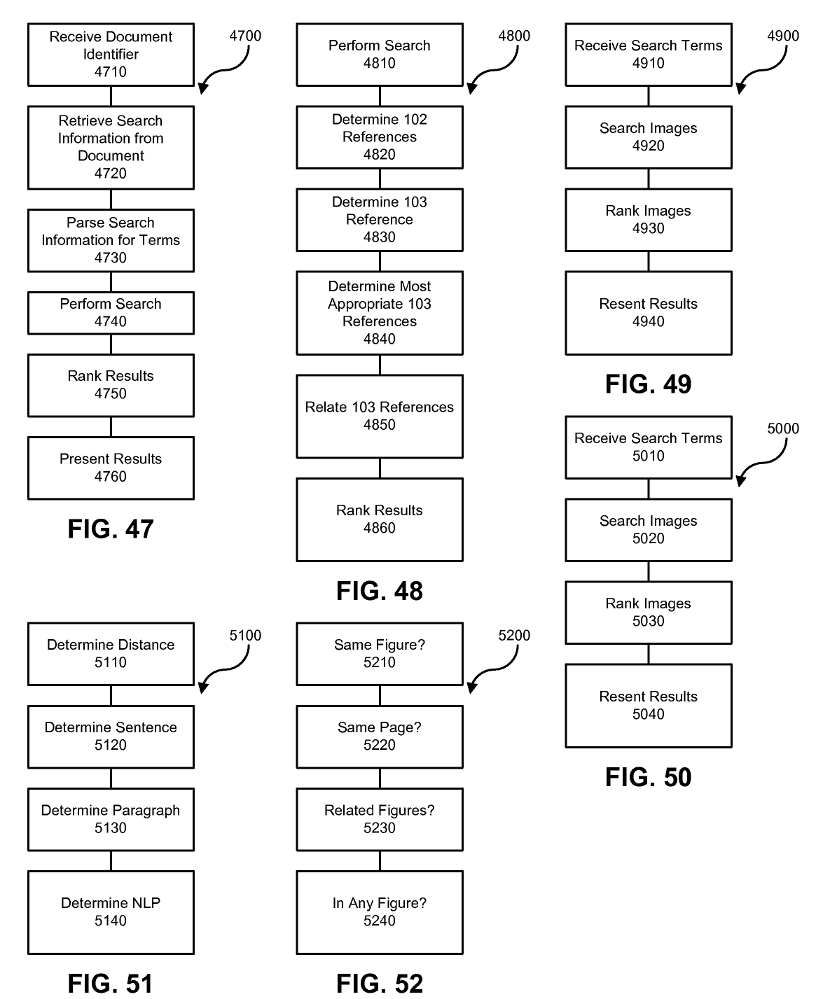

FIG. 47 is a method 4700 of performing a search based on a document identifier. For example, where a user wishes to invalidate a patent, they may identify the patent and the search method may use the claims of the patent as the search term source.

In step 4710, a document identifier is received. The document identifier may be, for example, a patent number. The document identifier may also include more information, such as a particular claim of the patent, or a drawing figure number. When used for an invalidity search, the existing patent or patent application may be used as the source of information for the search.

In step 4720, the claims of the patent identified in step 4710 are received. The claims may be separated by claim number, or the entire section may be received for use.

In step 4730, the claim text may be parsed to determine the relevant key words for use in a term search. For example, the NLP method (described herein) may be used to determine the noun phrases of the claim to extract claim elements. Moreover, the verbs may be used to determine additional claim terms. Alternatively, the claim terms may be used as-is without modification or culling of less important words. In another example, the claim preamble may not be used as search terms. In another example, the preamble may be used as search terms. Alternatively, the claim preamble may be used as search terms, but may be given a lower relevancy than the claim terms. Such a system allows for enhanced relevancy of the document that also includes the preamble terms as being more relevant than a document searched that does not include the preamble terms. In another example, the disclosure of the application may be used as search terms, and may be provided less term-weighting, to allow for a higher ranking of searched documents that include similar terms as the disclosure.

In step 4740, the search may be performed using the search terms as defined or extracted by step 4730. In an example, simple text searching may be used. In another example, the enhanced search method using field boosting may be applied (see FIG. 44), when performing a novelty/invalidity search.

In step 4750, the search results are output to the user. Where a result includes all terms searched, the method may indicate that the reference includes all terms. For example, when performing a novelty/invalidity search, such a document may be indicated as a “35 U.S.C. § 102” reference (discussed herein as a “102” reference). Alternatively, using the methods discussed herein, it is also possible to determine if all of the search terms are located within the same drawing page or the same figure. Such a search result may then be indicated as a strong “102” reference. In another example, where all of the search terms are located in a result in the same paragraph or discussion in the detailed description, such a result would also be considered a “102” reference.

The method 4700 may be iterated for each claim of the patent identified by patent number to provide search results (e.g., references) that closely matches the claims in patent identified for invalidation.

FIG. 48 is a method of creating combinations of search results related to search terms, where method 4800 replaces the steps 4740 and 4750 of FIG. 47. In general, the “102” references may be found, as well as potential “35 U.S.C. § 103” references (discussed herein as a “103” reference). The method then allows for determining and ranking the best references, even if all search terms were not found in a single reference.

In step 4810, the search is performed using search terms and results are provided.

In step 4820, the results are reviewed to determine the most relevant reference, for example, the “102” references, may be ranked higher than others.

In step 4830, the results are reviewed to determine which results do not contain all of the search terms. These references are then deemed to be potential “103” references.

In step 4840, the most appropriate “103” references are reviewed from the search results to determine their relevancy ranking. For example, “103” references that contain more of the search terms are considered more relevant than results with fewer search terms.

In step 4850, the “103” references are related to each other. The results are paired up to create a combination result. This provides that a combination of references contain all of the search terms. For example, where the search terms are “A B C D”, references are matched that, in combination, contain all of the source terms (or as many search terms as possible). For example, where result 1 contains A and B, and result 2 contains C and D, they may be related to each other (e.g., matched) as a combined result that includes each of the search terms. In another example, where result 3 contains A and C and D, the relation of result 1 and result 3 has higher relevancy than the combination of result 1 and result 2, due to more overlap between search terms. In general, the more overlap between the references, the improved relevancy of the combination. Moreover, a secondary method may be performed on the references to determine general overlap of the specifications to allow for combinations of references that are in the same art field. This may include determining the overlap of keywords, or the overlap of class/subclass (e.g., with respect to a patent document).

In step 4860, the results are ranked. In an example, the “102” references are determined to be more relevant than the “103” references and are then ranked with higher relevancy. The “103” reference combinations are then ranked by strength. For example, the “103” reference with all search terms appearing in the drawings may be ranked higher than “103” references with search terms appearing in the background section.

In general, method 4800 may be used to provide results that are a combination of the original search results. This may be used where a single result does not provide for all of the search terms being present. As explained herein, the method 4800 may be used for patent document searching. However, other searches may use similar methods to provide the necessary information. In an example, when researching a scientific goal, the goals terms may be input and a combination of results may provide the user with an appropriate combination to achieve the goal. In another example, when researching a topic, a search may be performed on two or more information goals. A single result may not include all information goals. However, a combination of results may provide as many information goals as possible.

Alternatively, a report can be built for “102” references. The location of the “102” citations may be provided by column/line number and figure number, as may be helpful when performing a novelty search. A “103” reference list and arguments may be constructed by listing the “103” references, the higher relevancy determined by the higher number of matching search terms. E.g., build arguments for reference A having as elements X, Y and reference B having elements Y, Z. When performing “103” reference searches, the output may be provided as a tree view. The user may then “rebalance” the tree or list based on the best reference found. For example, if the user believes that the third reference in the relevancy list is the “best starting point”, the user may click the reference for rebalancing. The method may then re-build the tree or list using the user defined reference as the primary reference and will find art more relevant to that field to build the “103” reference arguments that the primary reference does not include.

In determining the “103” reference arguments, NLP may be used to determine motivation to combine the references. Correlation of search terms, or other terms found in the primary and secondary references may be used to provide a motivation to combine them. For example, use of word (or idea) X in reference A and then use of word (or idea) X in reference B shows that there is a common technology, and a motivation to combine or an obvious to combine argument. Such an argumentation determination system may be used to not only locate the references, but rank them as a relevant combination. In another example, argument determination may be used in relation to a common keyword or term and the word X may be near the keyword in the references, providing an inference of relevance.

As an alternative to a ranked list of references, a report may be generated of the best references found. In an example, a novelty search may produce a novelty report as a result. The report may include a listing of references, including a listing of what terms were not found in each references, allowing the user to find “103” art based on those missing terms. Where the search terms are found in the reference, the most relevant figure to each term may be produced in the report to provide the user a simplified reading of the document. Moreover, the figures may have the element names labeled thereupon for easier reading. In an example, where three “102” references are found, the report may list the figures with labeled elements for first reference, the move on to the next references.

In an interactive report, the user may click on the keywords to move from figure to figure or from the text portion to the most from figure relating to that text. The user may also hit “next” buttons to scroll through the document to the portions that are relevant to the search terms, including the text and figures. Report generation may also include the most relevant drawing for each reference, elements labeled, search terms bolded, and a notation for each. E.g., a notation may include the sentences introducing the search term and/or the abstract for the reference. This may be used as a starting point for creating a client novelty report. For each relevant portion of the document, there may be citations in the report to the text location, figure, element, and column/line or paragraph (for pre-grant publication). The user may then copy these citations for a novelty report or opinion. Such notations may also be useful, for example, to patent examiners when performing a novelty search

FIG. 49 is a method of identifying the most relevant image related to search terms.

In step 4910, search terms are received.

In step 4920, a search is performed on images using the search terms. The search may include a general search of a plurality of documents. When searching a plurality of documents, the search terms may be applied to different fields/sections of the document, including fields/sections that provide information about the image. For example, when searching patent documents, the Section E of FIG. 35 may include information about the patent figures, including the related element names, that are searched using the search terms. Alternatively, the search may include a plurality of images of a single document. In a single patent document, the most relevant drawing or figure may be searched for.

In step 4930, the images are ranked. For example, in a patent document, the figure that includes the most search terms becomes most relevant. Additionally, information from the text related to the image (if such text exists) may be searched to provide additional relevancy information for ranking the images. For example, where the text of the document(s) includes a discussion linked to the image, the search terms may be applied to the discussion to determine whether the image is relevant, and/or whether the image is more relevant than other images in the search realm.

In step 4940, the image(s) are presented in a results output. When searching a plurality of documents for images, or images alone, the images may be presented to the user in a graphical list or array. When searching in a single document, the image may be presented as the most relevant image related to that document. In an example, when performing a patent search the results may be provided in a list format. Rather than providing a “front page” image, the results display may provide an image of the most relevant figure related to the search to assist the user in understanding each result.

Additionally, steps may be performed (as described herein) to generally identify the most relevant drawings to search term(s) (e.g. used for prior art search). The keywords/elements within the text may be correlated as being close to each other or relevant to each other by their position in the document and/or document sections. The text elements within the figures may also be related to the text elements within the text portion of the document (e.g., relating the element name from the specification to the element number in the drawings). The figures may then be ranked by relevancy to the search terms, the best matching figures/images being presented to the user before the less relevant figures/images. Such relevancy determinations may include matching the text associated with the figure to the search terms or keywords.

FIG. 50 is a method of relating images to certain portions of a text document. For example, when performing an invalidity analysis on a patent, a report may include a claim chart for each claim element. For each claim element, the figure of the invalidating reference (and/or the patent to be invalidated) may be determined and placed in the chart for user reference. In this way, an example of the method may identify the most relevant drawings per prior art claim (used for non-infringement search or an invalidity search).

In step 5010, a claim may be analyzed to determine the claim element to be used as the search term. When determined, the claim term is received as the search term, as well as the rest of the terms for the search.

In step 5020, the images of the invalidating reference are searched to provide the best match. The search term that relates to the particular claim element is given a higher relevancy boosting and the rest of the claim terms are not provided boosting (or less boosting). For example, where a portion of a claim includes “a transmission connected by a bearing”, and when searching for the term “bearing”, the search term “bearing” is provided higher boosting than “transmission”. By searching for both terms, however, the image that provides relevancy to both allows the user to view the searched term in relation to the other terms of the claim. This may be of higher user value than the term used alone in an image. Alternatively, the term “bearing” may be searched alone, and providing negative boosting to the other elements. Such a boosting method allows for providing an image that includes that term alone, which may provide more detail than a generalized image that includes all terms.

Where the invalidity analysis uses a single prior art reference, that single reference may be searched. Where the invalidity analysis uses multiple prior art references, the best matching reference to the search term may be used, or a plurality of references may be searched to determine the most relevant image.

In step 5030, the images are ranked. The images may be ranked using the boosting methods as discussed herein to determine which image is more relevant than others.

In step 5040, the results are presented to the user. If providing a list of references, the most relevant image may be presented. If providing a report on a claim for invalidation, each claim term may be separated and an image for each term provided which allows the user to more easily compare the claim to the prior art image.

FIG. 51 is a method of determining relevancy of documents (or sections of documents) based on the location of search terms within the text.

In step 5110, in general, the relevancy of a document or document section may be determined based on the distance between the search terms within the document. The distance may be determined by the linear distance within the document. Alternatively, the relevancy may be determined base on whether the search terms are included in the same document section or sub-section.

In step 5120, the relevancy may be determined by the keywords being in the same sentence. Sentence determination may be found by NLP, or other methods, as discussed herein.

In step 5130, the relevancy may be determined by the keywords being in the same paragraph.

In step 5140, the relevancy may be determined by using NLP methods that may provide for information about how the search terms are used in relation to each other. In one example, the search terms may be a modifier of the other (e.g., as an adjective to a noun).

FIG. 52 is a method of determining relevancy of images based on the location of search terms within the image and/or the document.

In step 5210, the relevancy may be determined by the search terms appearing on the same figure. Where in the same figure, the relationship of the search terms may be inferred from them being part of the same discussion or assembly.

In step 5220, the relevancy may be determined by the search terms appearing on the same page (e.g., the same drawing page of a patent document).

In step 5230, the relevancy may be determined by the search terms appearing on related figures. For example, where one search term is related to “FIG. 1A” and the second search term is related to “FIG. 1B”, an inference may be drawn that they are related because they are discussed in similar or related figures.

In step 5240, relevancy may be determined based on the search term being discussed with respect to any figure or image. For example, when the search term is used in a figure, an inference may be drawn that the term is more relevant in that document than the term appearing in another document but is not discussed in any figure. In this way, the search term/keyword discussed in any figure may show that the element is explicitly discussed in the disclosure, which leads to a determination that the search term is more important than a keyword that is only mentioned in passing in the disclosure of another document.

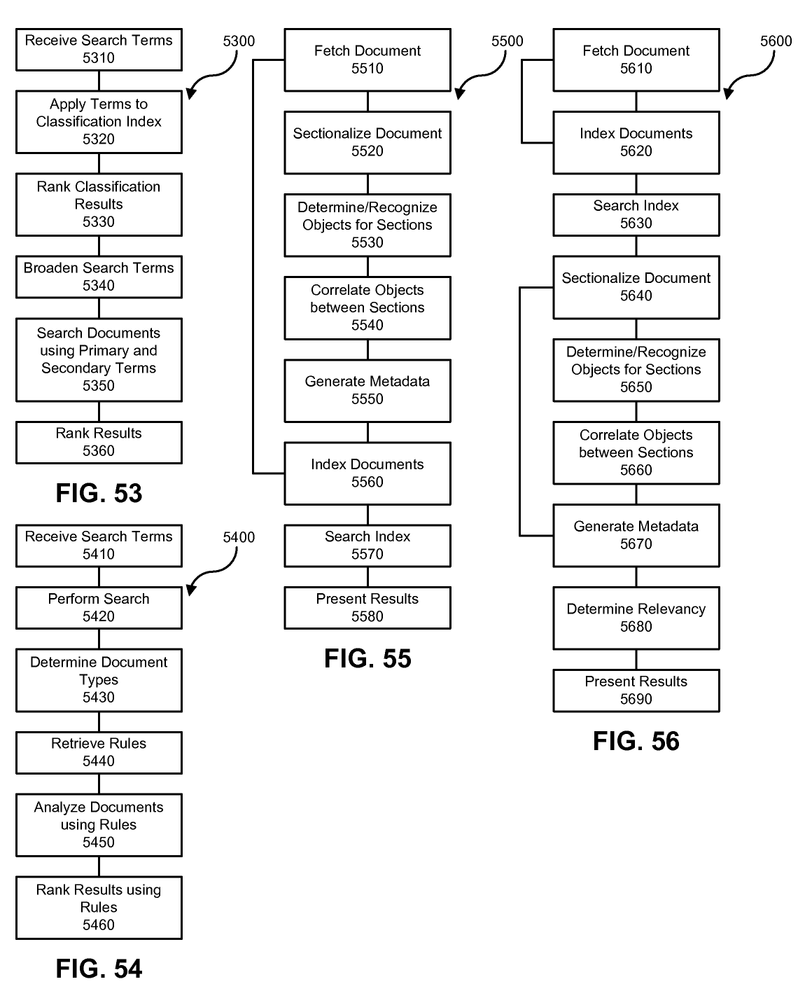

FIG. 53 is a search term broadening method 5300. In an example, the use of specific search terms (or keywords) may unnecessarily narrow the search results and/or provide results that miss what would otherwise be relevant documents in the results. To avoid undue narrowing of a keyword search, broadening of the terms may be applied to the search terms using thesauri. In another example, a context-based synonym for a keyword may be derived from a thesaurus, or a plurality of thesauri, selected using the search terms. The synonym(s) may then be applied to the each search term to broaden the search, at least to avoid undesired narrowing inherent in keyword searching. A plurality of thesauri may be generated from the indexed documents, based on the Document Group, Document Type, and Document Section.

In step 5310, search terms are received from a user or other process.

In step 5320, the search terms may be applied to a search index having classification information to determine the probable classes and/or subclasses that the search terms are relevant to.

In step 5330, the classification results are received and ranked. The particular classes and/or subclasses are determined by the relevancy of the search terms to the general art contained within the classes/subclasses.

In step 5340, a thesaurus for each class/subclass is applied to each search term to provide a list of broadened search terms. The original search terms may be indicated as such (e.g., primary terms), and the broadened search terms indicated as secondary terms.

In step 5350, the list of primary and secondary search terms are used to search the document index(es).

In step 5360, results are ranked according to primary and secondary terms. For example, the documents containing the primary terms are ranked above the documents containing the secondary terms. However, where documents contain some primary terms and some secondary terms, the results containing the most primary terms and secondary terms are ranked above documents containing primary terms but without secondary term. In this way, more documents likely to be relevant are produced in the results (and may be ranked more relevant) that otherwise would be excluded (or ranked lower) because the search terms were not present.

FIG. 54 is an example of a method 5400 of determining relevancy after search results are retrieved. Such a method may be used where storage of document sections and metadata may be excessively large to store in a pre-indexed fashion.

In step 5410, search terms are received.

In step 5420, a search is performed using the search terms of 5410.

In step 5430, the document types for each document provided as a result of the search are determined. The determination of document type may be based on the document itself or information related to the document. In another example, the document type may be determined at indexing and stored in the index or another database.

In step 5440, the rule associated with each document type is retrieved.

In step 5450, the search results documents are analyzed based on the rules associated with each document (e.g., by that document's type).

In step 5460, relevancy determination and ranking are determined based on the rules and analysis of the documents. As discussed herein the document may be analyzed for certain terms that may be more important than general words in the document (e.g., the numbered elements of a patent document may be of higher importance/relevancy than other words in the document), or the relevancy of the search terms appearing in certain document sections, including the drawings, may be used to determine the relevancy of the documents.

FIG. 55 is an example of a method 5500 for generally indexing and searching documents.

In step 5510, a document is fetched, for example using a crawler or robot.

In step 5520, a document is sectionalized. The document may be first typed and a rule retrieved or determined for how to sectionalize the document.

In step 5530, the objects for each section are determined and/or recognized.

In step 5540, the objects are correlated within sections and between sections within the document.

In step 5550, metadata may be generated for the document. The metadata may include information about the document itself, the objects determined in the document, and the linking within and between sections of the document.

In step 5560, the document is indexed. The indexing may include indexing the document and metadata, or the document alone. The metadata may be stored in a separate database for use when the index returns a search result for the determination of relevancy after or during the search. The method may repeat with step 5510 until all documents are indexed. Alternatively, the documents may be continuously indexed and the search method separated.

In step 5570, the index is searched to provide a ranked list of results by relevancy.

In step 5580, the results may be presented to the user or another process.

FIG. 56 is an alternative example, where indexing may be performed on the document text and document analysis and relevancy determination is performed after indexing.

In step 5610, a document is fetched, for example using a crawler or robot.

In step 5620, the document is indexed. The indexing may include indexing the document as a text document. The method may repeat with step 5610 until all documents are indexed. Alternatively, the documents may be continuously indexed and the search method separated.

In step 5630, the index is searched to provide a ranked list of results by relevancy.

In step 5640, a document is sectionalized. The document may be first typed and a rule retrieved or determined for how to sectionalize the document.

In step 5650, the objects for each section are determined and/or recognized.

In step 5660, the objects are correlated within sections and between sections within the document.

In step 5670, metadata may be generated for the document. The metadata may include information about the document itself, the objects determined in the document, and the linking within and between sections of the document. The process may then continue with the next document in the search result list at step 1340 until the documents are sufficiently searched (e.g., until the most relevant 1000 documents in the initial list—sorted by initial relevancy—are analyzed).

In step 5690, the relevancy of the documents may be determined using the rules and metadata generated through the document analysis.

In step 5680, the results may be presented to the user or another process.

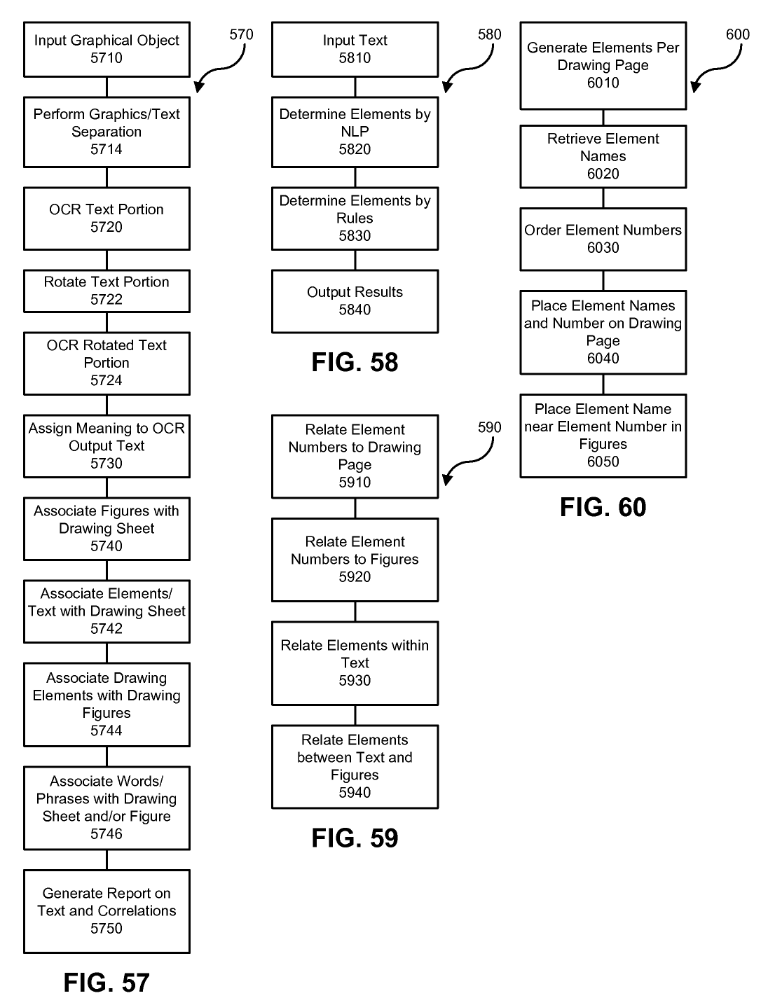

FIG. 57 is a method 570 for identifying text elements in graphical objects, which may include patent documents. For the analysis of documents, it may be helpful to identify numbers, words, and/or symbols (herein referred to as “element identifiers”) that are mixed with graphical elements and text portions of the document, sections, or related documents. However, existing search systems have difficulty with character recognition provided in mixed formats. One example of a method for identifying characters in mixed formats includes separating graphics and text portions and then applying OCR methods to the text portions. Moreover, in some circumstances, the text portion may be rotated to further assist the OCR algorithm when the text portion further includes horizontally, vertically, or angularly oriented text.

Method 570 is an example of identifying element numbers in the drawing portion of patent documents. Although this method described herein is primarily oriented to OCR methods for patent drawings, the teachings may also be applied to any number of documents having mixed formats. Other examples of mixed documents may include technical drawings (e.g., engineering CAD files), user manuals including figures, medical records (e.g., films), charts, graphics, graphs, timelines, etc. As an alternative to method 570, OCR algorithms may be robust and recognize the text portions of the mixed format documents, and the forgoing method may not be required in its entirety.

In step 5710, a mixed format graphical image or object is input. The graphical image may, for example, be in a TIFF format or other graphical format. In an example, a graphical image of a patent figure (e.g., FIG. 1) is input in a TIFF format that includes the graphical portion and includes the figure identifier (e.g., FIG. 1) as well as element numbers (e.g., 10, 20, 30) and lead-lines to the relevant portion of the figure that the element numbers identify.

In step 5714, graphics-text separation is performed on the mixed format graphical image. The output of the graphics-text separation includes a graphical portion, a text portion, and a miscellaneous portion, each being in a graphical format (e.g., TIFF).

In step 5720, OCR is performed on the text portion separated from step 5714. The OCR algorithm may now recognize the text and provide a plain-text output for further utilization. In some cases, special fonts may be recognized (e.g., such as some stylized fonts used for the word “FIGURE” or “FIG” that are non-standard). These non-standard fonts may be added to the OCR algorithms database of character recognition.

In step 5722, the text portion may be rotated 90 degrees to assist the OCR algorithm to determine the proper text contained therein. Such rotation is helpful when, for example, the orientation of the text is in landscape mode, or in some cases, figures may be shown on the same page as both portrait and landscape mode.

In step 5724, OCR is performed on the rotated text portion of step 5722. The rotation and OCR of steps 5722 and 5724 may be performed any number of times to a sufficient accuracy.

In step 5730, meaning may be assigned to the plain-text output from the OCR process. For example, at the top edge of a patent drawing sheet, the words “U.S. Patent”, the date, the sheet number (if more than one sheet exists), and the patent number appear. The existence of such information identifies the sheet as a patent drawing sheet. For a pre-grant publication, the words “Patent Application Publication”, the date, the sheet number (if more than one sheet exists), and the publication number appear. The existence of such information identifies the sheet as a patent pre-grant publication drawing sheet and which sheet (e.g., “Sheet 1 of 2” is identified as drawing sheet 1). Moreover, the words “FIG” or “FIGURE” may be recognized as identifying a figure on the drawings sheet. Additionally, the number following the words “FIG” or “FIGURE” is used to identify the particular figure (e.g., FIG. 1, FIG. 1A, FIG. 1B, FIGURE C, relate to FIGS. 1, 1A, 1B, C, respectively). Numbers, letters, symbols, or combinations thereof are identified as drawing elements (e.g., 10, 12, 30A, B, C1, D′, D″ are identified as drawing elements).

In step 5740, each of the figures may be identified with the particular drawing sheet. For example, where drawing sheet 1 of 2 contains FIGS. 1 and 2, the FIGS. 1 and 2 are associated with drawings sheet 1.

In step 5742, each of the drawing elements may be associated with the particular drawing sheet. For example, where drawings sheet 1 contains elements 10, 12, 20, and 22, each of elements 10, 12, 20, and 22 are associated with drawing sheet 1.

In step 5744, each of the drawing elements may be associated with each figure. Using a clustering or blobbing technique, each of the element numbers may be associated with the appropriate figure. See also FIG. 7A and FIG. 20.

In step 5746, complete words or phrases (if present) may be associated with the drawing sheet, and figure. For example, the words of a flow chart or electrical block diagram (e.g., “transmission line” or “multiplexer” or “step 10, identify elements”) may be associated with the sheet and figure.

In step 5750, a report may be generated that contains the plain text of each drawing sheet as well as certain correlations for sheet and figure, sheet and element number, figure and element number, and text and sheet, and text and figure. The report may be embodies as a data structure, file, or database entry, that correspond to the particular mixed format graphical image under analysis and may be used in further processes.

In an example, FIG. 35 explained above in detail, a formatted document is provided that includes identifying information, or metadata, for each text portion of a mixed-format graphical document. An example of such a formatted document may include an XML document, a PDF document that includes metadata, etc.

FIG. 58 is an example of a method 580 for extracting relevant elements and/or terms from a document. For example, a text document (e.g., a full-text patent document or an OCR of a text document) certain element identifiers may be determined and associated with words that indicate element names (e.g., “transmission 10” translates to element name “transmission” that is correlated with element identifier “10”). In other example, a text document may be generated from a text extraction method (e.g., as described in FIG. 57).

In step 5810, text is input for the determination of elements and/or terms. The input may be any input that may include a patent document, a web-page, or other documents.

In step 5820, elements are determined by Natural Language Processing (NLP). These elements may be identified from the general text of the document because they are noun phrases, for example. For example, an element of a patent document may be identified as a noun phrase, without the need for element number identification (as described below).

In step 5830, elements may be identified by their being an Element Number (e.g., an alpha/numeric) present after a word, or a noun phrase. For example, an element of a patent document may be identified as a word having an alpha/numeric immediately after the word (e.g., (“transmission 18”, “gear 19”, “pinion 20”).

FIG. 59 is a method 590 for relating text and/or terms within a document. In analyzing a document, it may be helpful to relate element identifiers, words, or other identifiers with different document portions. The document portions may include a title, text section, drawing sheet, figure, etc. The text section, in the context of a patent document, may include the title, background, summary, brief description of drawings, detailed description, claims, and abstract. For example, relation of elements may be between drawing pages and text portions, different text sections, drawing figures and text section, etc.

Using method 590, elements may be identified by numeric identifiers, such as text extracted from drawing figures as element numbers only (e.g., “18”, “19”, “20”) that may then be related to element names (“18” relates to “transmission”, “19” relates to “gear”, “20” relates to “pinion”).

In step 5910, element numbers are identified on a drawing page and related to that drawing page. For example, where a drawing page 1 includes FIGS. 1 and 2, and elements 10-50, element numbers 10-50 are related to drawing page 1. Additionally, the element names (determined from a mapping) may be associated with the drawing page. An output may be a mapping of element numbers to the figure page, or element numbers with element names mapped to the figure page. If text (other than element numbers) is present, the straight text may be associated to the drawing page.

In step 5920, element numbers are related to figures. For example, the figure number is determined by OCR or metadata. In an example, the element numbers close to the drawing figure are then associated with the drawing figure. Blobbing, as discussed herein, may be used to determine the element numbers by their x/y position and the position of the figure. Additionally, element lines (e.g., the lead lines) may be used to further associate or distinguish which element numbers relate to the figure. An output may be a mapping of element numbers and/or names to the figure number. If text (other than element numbers) is present, the straight text may be associated to the appropriate figure.

In step 5930, elements may be related within text. For example, in the detailed description, the elements that appear in the same paragraph may be mapped to each other. In another example, the elements used in the same sentence may be mapped to each other. In another example, the elements related to the same discussion (e.g., a section within the document) may be mapped to each other. In another example, the elements or words used in a claim may be mapped to each other. Additional mapping may include the mapping of the discussions of figures to the related text. For example, where a paragraph includes a reference to a figure number, that paragraph (and following paragraphs up to the next figure discussion) may be mapped to the figure number.

In another example, figures discussed together in the text may be related to each other. For example, where FIGS. 1-3 are discussed together in the text, the FIGS. 1-3 may be related to each other. In another example, elements may be related within the text portion itself. Where a document includes multiple sections, the text may be related therebetween. An example may be the mapping of claim terms to the abstract, summary and/or detailed description.

In step 5940, elements may be related between text and figures. For example, elements discussed in the text portions may be related to elements in the figures. In an example, where the text discussion includes elements “transmission 10” and “bearing 20”, FIG. 1 may be mapped to this discussion in that FIG. 1 includes elements “10” and “20”. Another example may include mapping claim terms to the specification and figures. For example, where a claim includes the claim term “transmission”, the mapping of “transmission” to element “10” allows the claim to figure mapping of figures that include element “10”. In another example, matching of text elements with drawing elements includes relating “18a, b, c” in text to “18a”, “18b” and “18c” the in drawings. Using these mappings discussed and/or the mappings of the figures and/or drawing pages, the elements may then be fully related to each other within the document. The mappings may then be used for analyzing the document, classifying, indexing, searching, and enhanced presentation of search results.

FIG. 60 is a method of listing element names and numbers on a drawing page of a patent. Such a listing may be helpful to the patent reader to quickly reference the element names when reviewing the drawing figures, and avoid lengthy lookup of the element name from the specification.

In step 6010, a list of element per drawing page is generated. The element numbers may be identified by the OCR of the drawings or metadata associated with the drawings or document.

In step 6020, element names are retrieved from the patent text analysis. The mapping of element name to element number (discussed herein) may be used to provide a list of element names for the drawing page.

In step 6030, drawing elements for a page are ordered by element number. The list of element numbers and element names are ordered by element number.

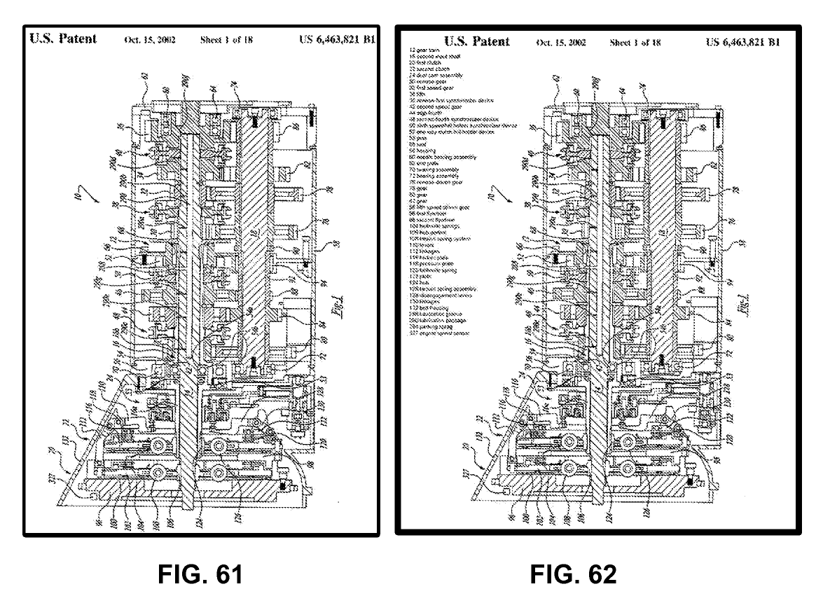

In step 6040, element numbers and element names are placed on the drawing page. The listing of element names/numbers for the drawing page may then be placed on the drawing page. In an example, areas of the drawing page having white space are used as the destination for the addition of element names/numbers to the drawing page. FIG. 61 is an example of a drawing page before markup, and FIG. 62 is an example of a drawing page after markup.

In step 6050, element names are placed next to element numbers in each figure on a drawing page. If desired, the element names may be located and placed next to the element number in or at the figure for easier lookup by the patent reader.

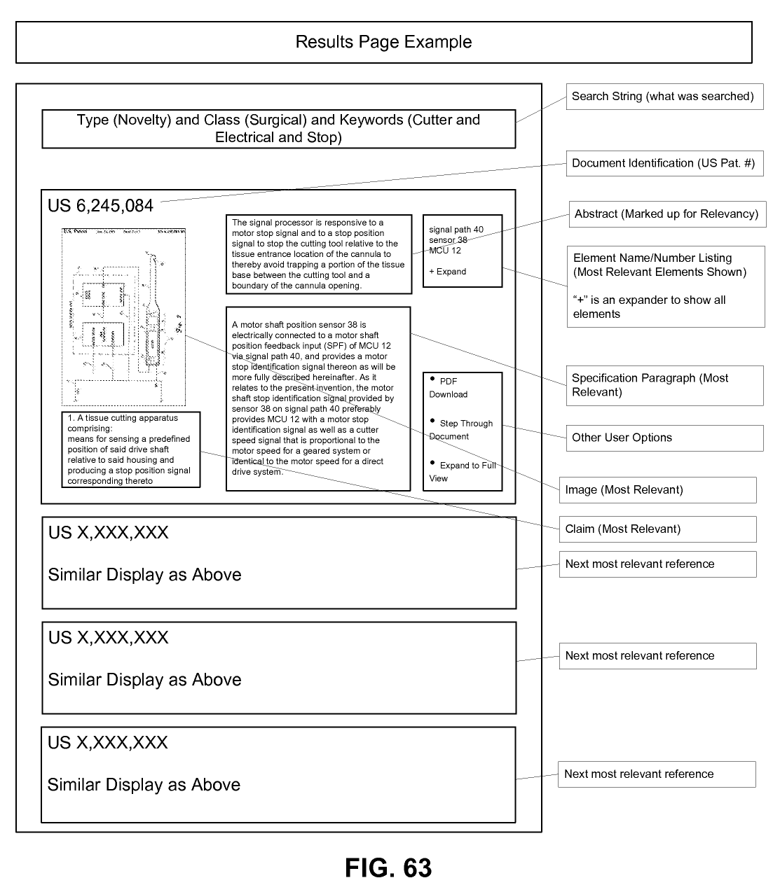

FIG. 63 is an example of a search results screen for review by a user. Each result may include the patent number, a drawing, a claim, an abstract, and detailed description section. The drawing may be selected as the most relevant drawing based on the search term (the most relevant drawing determination is described herein), rather than the front page image. The most relevant claim may also be displayed with respect to the search terms, rather than the first claim. The abstract may also be provided at the most relevant section. The specification section may also be provided that is the most relevant to the search terms. In each output, the search terms may be highlighted, including highlighting for the drawing elements (based on element name to element number mapping from the specification) to quickly allow the user to visualize the information from the drawing figure. Other information may also be provided allowing the user to expand the element numbers for the patent and navigate through the document.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided will be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

We claim:

1. A method for associating graphical information and text information, comprising:
providing said graphical information, said graphical information comprising at least one identifier in the graphical information for identifying at least one portion of the graphical information;
providing said text information; and
associating the portion with the text information through a commonality between the identifier and the text information.

2. The method of claim 1, further comprising:
associating a search term with the commonality.

3. The method of claim 1, wherein said associating further comprises:
identifying an alpha numeric reference as a commonality in the graphical information;
identifying said alpha numeric reference in the text information; and
relating a textual description in proximity to said alpha numeric reference in the text information to said alpha numeric reference in the graphical information.

4. The method of claim 3, wherein the alpha numeric reference is adjacent to the text information.

5. The method of claim 1, further comprising:
providing a plurality of images in the graphical information; and
associating at least one of said plurality of images to at least one search term through said commonality.

6. The method of claim 5, further comprising:
determining a frequency of said at least one search term for each of said plurality of images; and
determining a relevancy ranking for each of said plurality of images by said frequency.

7. The method of claim 1, wherein the text information is a text portion of a patent document and the graphical information is figures for the patent document.

8. The method of claim 1, further comprising:
providing a plurality of documents, each of said documents including said text information;
dividing each of the documents into a plurality of fields;
assigning a plurality of relevancy factors for the plurality of fields; and
determining a relevancy for each of the documents based on each of the relevancy factors for each of the fields in which the search term is located.

9. The method of claim 8, further comprising:
determining a relevancy for at least one of the plurality of fields is based on the existence of commonalities in at least one of said plurality of fields.

10. The method of claim 8, further comprising:
determining at least one document type for at least one of said plurality of documents;
providing a rule for said at least one document type; and
analyzing said at least one of said plurality of documents using said rule.

11. A device for associating graphical information with text information, comprising:
a text portion;
a graphical portion; and
means for associating the text portion with the graphical portion.
